(19) United States
(12) Patent Application Publication
(10) Pub. No.: US 2015/0162590 A1
(43) Pub. Date: Jun. 11, 2015

(54) POWER STORAGE DEVICE, METHOD FOR MANUFACTURING THE SAME, AND ELECTRONIC DEVICE

(71) Applicant: SEMICONDUCTOR ENERGY LABORATORY CO., LTD., Atsugi-shi (JP)

(72) Inventors: Minoru TAKAHASHI, Matsumoto (JP); Ryota TAJIMA, Isehara (JP)

(21) Appl. No.: 14/553,270

(22) Filed: Nov. 25, 2014

(30) Foreign Application Priority Data
Dec. 6, 2013 (JP) 2013-253409

(51) Int. Cl. H01M 2/30; H01M 2/20; H01M 10/04

(52) U.S. Cl. CPC H01M 2/30; H01M 10/04; H01M 2/202

(57) ABSTRACT

Provided is a power storage device having a positive electrode and a negative electrode which are enveloped in an exterior body. The positive electrode has a first tab region which extends outside the exterior body so as to electrically connect the positive electrode to a positive electrode lead. Similarly, the negative electrode has a second tab region which extends outside the exterior body so as to electrically connect the negative electrode to a negative electrode lead. Each of the first tab region and the second tab region has a plurality of holes which are placed in the exterior body. A method for fabricating the power storage device is also disclosed.

### BACKGROUND OF THE INVENTION

1. Field of the Invention

The present invention relates to a power storage device, a manufacturing method thereof, and a semiconductor device including the power storage device.

In this specification, the power storage device is a collective term describing units and devices having a power storage function.

2. Description of the Related Art

In recent years, a variety of power storage devices, for example, secondary batteries such as lithium-ion secondary batteries, lithium-ion capacitors, and air batteries, have been actively developed. In particular, demand for lithium-ion secondary batteries with high output and high energy density has rapidly grown with the development of the semiconductor industry. The lithium-ion secondary batteries are essential as rechargeable energy supply sources for today's information society. Such lithium-ion secondary batteries have been applied to electronic devices including portable information terminals such as mobile phones, smartphones, and laptop computers, portable music players, and digital cameras; medical equipment; and next-generation clean energy vehicles such as hybrid electric vehicles (HEVs), electric vehicles (EVs), and plug-in hybrid electric vehicles (PHEVs).

The performance required for power storage devices such as lithium-ion secondary batteries includes increased energy density, improved cycle characteristics, safe operation under a variety of environments, and longer-term reliability.

A lithium-ion battery includes a positive electrode, a negative electrode, and an electrolyte solution (Patent Document 1).

### REFERENCE

### Patent Document

### [Patent Document 1] Japanese Published Patent Application No. 2012-009418

### SUMMARY OF THE INVENTION

An object of one embodiment of the present invention is to provide a power storage device having high capacity per volume or weight. Another object of one embodiment of the present invention is to provide a power storage device with high energy density.

Another object of one embodiment of the present invention is to provide a highly reliable power storage device. Another object of one embodiment of the present invention is to provide a long-life power storage device.

Another object of one embodiment of the present invention is to provide an electrode of a bendable power storage device. Another object of one embodiment of the present invention is to provide a bendable power storage device. Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the present invention is a manufacturing method of a power storage device that includes m positive electrodes (m is an integer of 2 or more) and n negative electrodes (n is an integer of 2 or more). The m positive electrodes each include a positive electrode current collector and a positive electrode active material layer in contact with at least one surface of the positive electrode current collector. The m positive electrodes each include a tab region in which at least part of the positive electrode current collector is exposed and a region in which the positive electrode current collector is covered with the positive electrode active material layer. The tab region of each of the m positive electrodes includes a hole. The n negative electrodes each include a negative electrode current collector and a negative electrode active material layer in contact with at least one surface of the negative electrode current collector. The n negative electrodes each include a tab region in which at least part of the negative electrode current collector is exposed and a region in which the negative electrode current collector is covered with the negative electrode active material layer. The tab region of each of the n negative electrodes includes a hole. The manufacturing method includes a step of alternately stacking the m positive electrodes and the n negative electrodes.

One embodiment of the present invention is a manufacturing method of a power storage device that includes m positive electrodes (m is an integer of 2 or more) and n negative electrodes (n is an integer of 2 or more). The m positive electrodes each include a positive electrode current collector and a positive electrode active material layer in contact with at least one surface of the positive electrode current collector. The m positive electrodes each include a tab region in which at least part of the positive electrode current collector is exposed and a region in which the positive electrode current collector is covered with the positive electrode active material layer. The tab region of each of the m positive electrodes includes a hole. The n negative electrodes each include a negative electrode current collector and a negative electrode active material layer in contact with at least one surface of the negative electrode current collector. The n negative electrodes each include a tab region in which at least part of the negative electrode current collector is exposed and a region in which the negative electrode current collector is covered with the negative electrode active material layer. The tab region of each of the n negative electrodes includes a hole. The manufacturing method includes a first step of bonding parts of the tab regions of the stacked m positive electrodes to each other; a second step of bonding parts of the tab regions of the stacked n negative electrodes to each other; and a third step of alternately stacking the m positive electrodes and the n negative electrodes.

In the above structure, the m positive electrodes are preferably stacked to make the holes in the m positive electrodes overlap with each other, and the n negative electrodes are preferably stacked to make the holes in the n negative electrodes overlap with each other.

One embodiment of the present invention is a power storage device including m positive electrodes (m is an integer of 2 or more) and n negative electrodes (n is an integer of 2 or more). The m positive electrodes each include a positive electrode current collector and a positive electrode active material layer in contact with at least one surface of the positive electrode current collector. The m positive electrodes each include a tab region in which at least part of the positive electrode current collector is exposed and a region in which the positive electrode current collector is covered with the positive electrode active material layer. The tab region of each of the m positive electrodes includes a hole. The n negative electrodes each include a negative electrode current collector and a negative electrode active material layer in contact with at least one surface of the negative electrode current collector. The n negative electrodes each include a tab region in which at least part of the negative electrode current collector is exposed and a region in which the negative electrode current collector is covered with the negative electrode active material layer. The tab region of each of the n negative electrodes includes a hole. The m positive electrodes and the n negative electrodes are alternately stacked.

The holes in at least two of the m positive electrodes preferably overlap with each other. The holes in at least two of the n negative electrodes preferably overlap with each other. It is preferable that the holes in the m positive electrodes and the holes in the n negative electrodes not be perfect circles. It is preferable that the m positive electrodes and the n negative electrodes each include a plurality of holes.

One embodiment of the present invention is an electronic device including the above-described power storage device.

One embodiment of the present invention makes it possible to provide a power storage device having high capacity per volume or weight. One embodiment of the present invention makes it possible to provide a power storage device with high energy density.

One embodiment of the present invention makes it possible to provide a highly reliable power storage device. One embodiment of the present invention makes it possible to provide a long-life power storage device.

One embodiment of the present invention makes it possible to provide an electrode of a bendable power storage device. One embodiment of the present invention makes it possible to provide a bendable power storage device. Note that the descriptions of these effects do not disturb the existence of other effects. In one embodiment of the present invention, there is no need to achieve all the effects. Other effects will be apparent from and can be derived from the description of the specification, the drawings, the claims, and the like.

### BRIEF DESCRIPTION OF THE DRAWINGS

FIGS. 1A to 1C illustrate a power storage device.

FIGS. 2A and 2B illustrate cross sections of a power storage device.

FIGS. 3A to 3C illustrate a manufacturing process of a power storage device.

FIGS. 4A and 4B illustrate a manufacturing process of a power storage device.

FIGS. 5A to 5C illustrate a manufacturing process of a power storage device.

FIGS. 6A and 6B illustrate a manufacturing process of a power storage device.

FIGS. 7A and 7B illustrate a manufacturing process of a power storage device.

FIGS. 8A to 8D illustrate a manufacturing process of a power storage device.

FIG. 9 illustrates an electrode of a power storage device.

FIGS. 10A and 10B illustrate a manufacturing process of a power storage device.

FIG. 11 illustrates a manufacturing step of a power storage device.

FIGS. 12A and 12B illustrate a manufacturing process of a power storage device.

FIGS. 13A and 13B each illustrate an electrode and a separator.

FIGS. 14A and 14B illustrate cross sections of a power storage device.

FIGS. 15A and 15B illustrate cross sections of a power storage device.

FIGS. 16A and 16B illustrate a power storage device.

FIGS. 17A and 17B illustrate a manufacturing process of a power storage device.

FIGS. 18A to 18C each illustrate a manufacturing step of a power storage device.

FIGS. 19A and 19B each illustrate an example of a power storage device.

FIGS. 20A1, 20A2, 20B1, and 20B2 each illustrate an example of a power storage device.

FIGS. 21A and 21B each illustrate an example of a power storage device.

FIGS. 22A to 22G illustrate thin and flexible power storage devices.

FIGS. 23A to 23C illustrate an application example of a power storage device.

FIG. 24 illustrates application examples of a power storage device.

FIGS. 25A and 25B illustrate application examples of a power storage device.

FIGS. 26A to 26C each illustrate a manufacturing step of a power storage device.

FIGS. 27A and 27B each illustrate an electrode of a power storage device.

FIGS. 28A to 28D each illustrate a manufacturing step of a power storage device.

FIGS. 29A and 29B illustrate a manufacturing process of a power storage device.

FIGS. 30A and 30B illustrate a manufacturing process of a power storage device.

FIGS. 31A and 31B illustrate a manufacturing process of a power storage device.

FIGS. 32A to 32J each illustrate a shape of a pin.

### DETAILED DESCRIPTION OF THE INVENTION

Embodiments of the present invention will be described below in detail with reference to the drawings. However, the present invention is not limited to the description below, and it is easily understood by those skilled in the art that modes and details disclosed herein can be modified in various ways. Furthermore, the present invention is not construed as being limited to description of the embodiments.

Note that in each drawing referred to in this specification, the size of each component or the thickness of each layer might be exaggerated or a region might be omitted for clarity of the invention. Therefore, embodiments of the present invention are not limited to such a scale.

Note that ordinal numbers such as “first” and “second” in this specification and the like are used in order to avoid confusion among components and do not denote the priority or the order such as the order of steps or the stacking order. A term without an ordinal number in this specification and the like might be provided with an ordinal number in a claim in order to avoid confusion among components.

### Embodiment 1

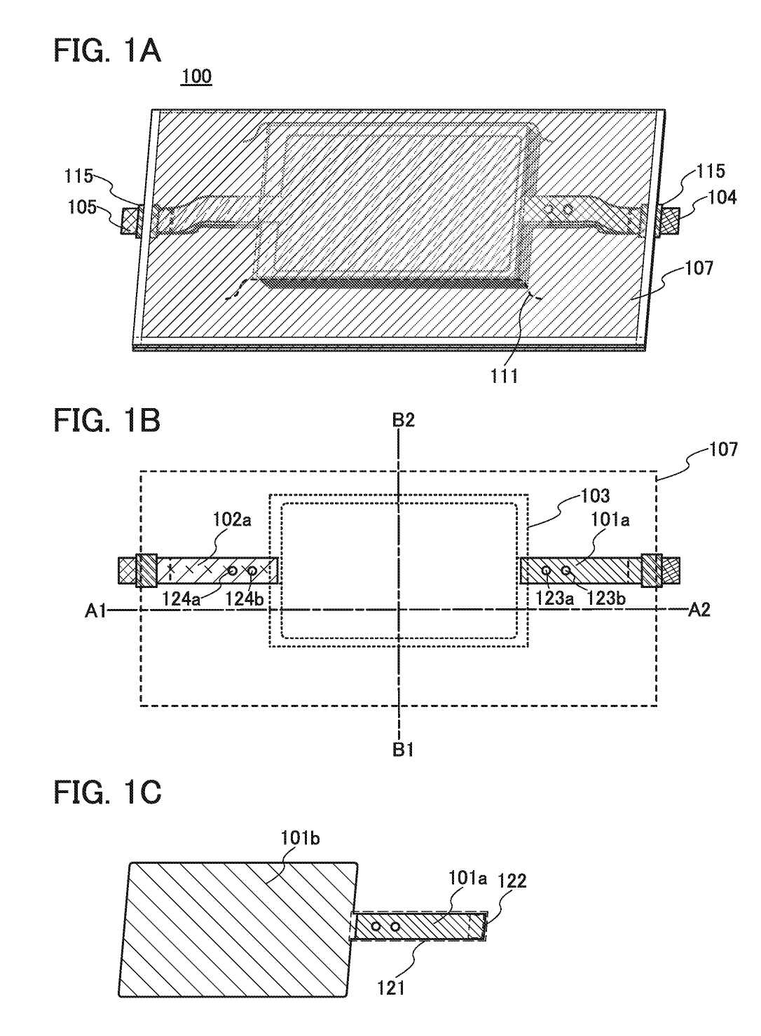

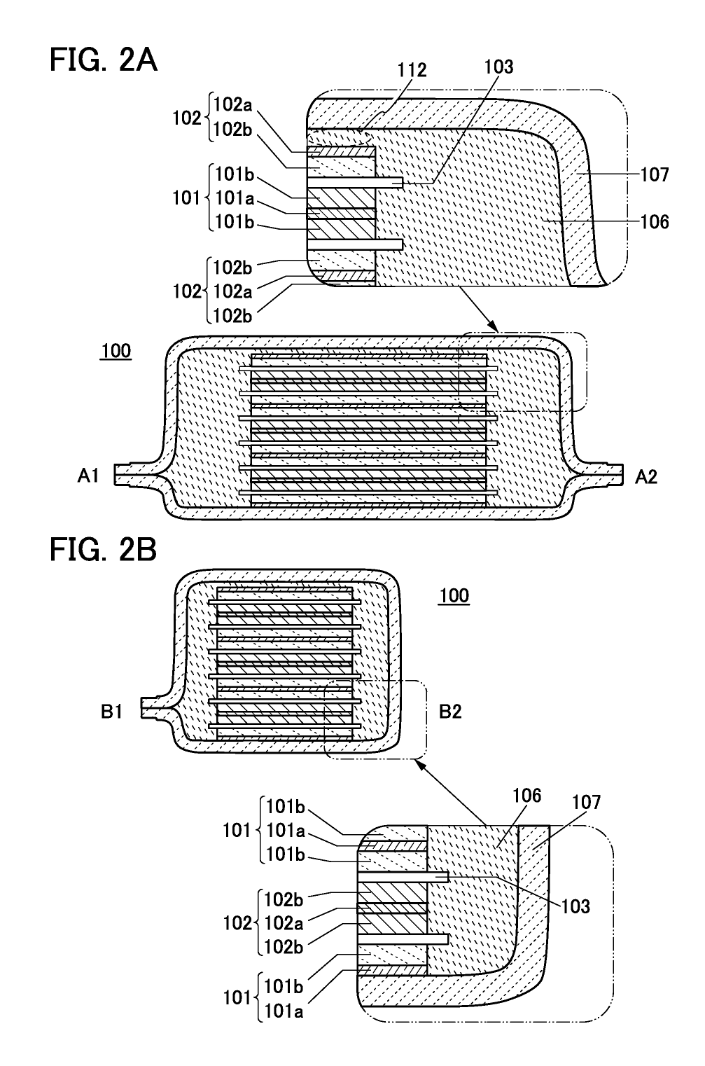

Structure examples of a power storage device 100 that is one embodiment of the present invention are described with reference to the drawings. FIG. 1A is a perspective view illustrating the external appearance of the power storage device 100. FIG. 1B is a top view of the power storage device 100. FIG. 2A and FIG. 2B illustrate the cross sections along the lines A1-A2 and B1-B2, respectively. The power storage device 100 illustrated in FIGS. 1A to 1C and FIGS. 2A, and 2B includes a positive electrode 101 and a negative electrode 102 that are surrounded by an exterior body 107. A separator 103 is provided between the positive electrode 101 and the negative electrode 102. It is preferable that a plurality of the positive electrodes 101 and the negative electrodes 102 be stacked with each other. The positive electrode 101 is electrically connected to a positive electrode lead 104, and the negative electrode 102 is electrically connected to a negative electrode lead 105. A sealing layer 115 is provided between the exterior body 107 and each of the positive electrode lead 104 and the negative electrode lead 105. The exterior body 107 is preferably provided with a projection, by which the positive electrode 101 and the stacked negative electrode 102 that are stacked can be easily enveloped with the exterior body 107. A dashed line in FIG. 1A is a ridge 111 of the projection of the exterior body 107. As shown in FIG. 2A, the positive electrode 101 includes a positive electrode current collector 101a and a positive electrode active material layer 101b, and the negative electrode 102 includes a negative electrode current collector 102a and a negative electrode active material layer 102b. The positive electrode active material layer 101b and the negative electrode active material layer 102b face each other with the separator 103 provided therebetween. An electrolyte solution 106 is injected into the inner side of the exterior body 107. The power storage device 100 may have a gap 112 between the negative electrode 102 and the exterior body 107 as illustrated in FIG. 2A, by which stress due to external force applied in bending the power storage device 100 can be relaxed. Note that although FIGS. 2A and 2B illustrate an example in which six pairs of the positive electrode active material layer 101b and the negative electrode active material layer 102b facing each other are stacked, the number of the pairs may be smaller or larger than six. The number of the pairs of the positive electrode active material layer 101b and the negative electrode active material layer 102b facing each other is preferably 2 to 80, for example. In the case of stacking a large number of pairs, the power storage device can have high capacity. In contrast, in the case of stacking a small number of pairs, the power storage device can have small thickness and high flexibility. The power storage device 100 illustrated in FIGS. 2A and 2B includes three positive electrodes 101 in each of which the positive electrode active material layer 101b is provided on both surfaces of the positive electrode current collector 101a; two negative electrodes 102 in each of which the negative electrode active material layer 102b is provided on both surfaces of the negative electrode current collector 102a; and two negative electrodes 102 in each of which the negative electrode active material layer 102b is provided on one surface of the negative electrode current collector 102a. That is, the three positive electrodes 101 and the four negative electrodes 102 are provided. As in this example, the number of the positive electrodes 101 and that of the negative electrodes 102 may be different from each other. In FIGS. 2A and 2B, only one surface of each of the current collectors of the uppermost and lowermost electrodes is provided with the active material layer; however, it is also possible to provide the active material layer on both surfaces of each of the current collectors. In the power storage device 100, the total thickness of the positive electrode active material layers 101b of the stacked positive electrodes 101 is preferably greater than or equal to 10 μm and less than or equal to 40 mm, further preferably greater than or equal to 30 μm and less than or equal to 20 mm. The total thickness of the negative electrode active material layers 102b of the stacked negative electrodes 102 is preferably greater than or equal to 10 μm and less than or equal to 40 mm, further preferably greater than or equal to 30 μm and less than or equal to 20 mm.

In the power storage device 100 of one embodiment of the present invention, the positive electrode 101, the negative electrode 102, the separator 103, and the electrolyte solution 106 are surrounded by the exterior body 107. Holes 123a and 123b for alignment are provided in a tab region of the positive electrode 101. Holes 124a and 124b for alignment are provided in a tab region of the negative electrode 102. The positive electrode 101 is electrically connected to the positive electrode lead 104, and the negative electrode 102 is electrically connected to the negative electrode lead 105. The positive electrode lead 104 and the negative electrode lead 105 are also called lead electrodes or lead terminals. Part of the positive electrode lead 104 and part of the negative electrode lead 105 are provided outside the exterior body. The power storage device 100 is charged and discharged through the positive electrode lead 104 and the negative electrode lead 105.

The tab region is a terminal of the current collector to connect with the lead electrode. FIG. 1C illustrates an example of a positive electrode. A bonding portion 122 of the positive electrode current collector 101a is a region where the positive electrode lead 104 and the positive electrode current collector 101a are bonded to each other. The tab region is, for example, a tab region 121 illustrated in FIG. 1C. Although FIG. 1C illustrates the positive electrode 101 as an example, the negative electrode 102 also includes a tab region, a bonding portion, and the like. It is preferable that the positive electrode active material layer 101b not be provided in a part, which is bonded to the positive electrode lead 104, of the tab region 121. The positive electrode active material layer 101b may be provided in part of the tab region 121. The same applies to the tab region of the negative electrode 102.

In the power storage device 100 illustrated in FIGS. 1A and 1B, the positive electrode 101 and the negative electrode 102 are stacked to face each other. When the positive electrode 101 or the negative electrode 102 is misaligned when being stacked, the overlapping area is decreased, which reduces the capacity of the power storage device 100. For this reason, the positive electrode 101 and the negative electrode 102 are preferably stacked to be misaligned as little as possible. An electric field is likely to concentrate at end portions of the positive electrode 101 and the negative electrode 102. When a voltage drop or the like due to the internal resistance of the battery causes a reduction in the potential of the negative electrode 102 to the reduction potential of lithium, lithium is deposited on a surface of the negative electrode 102 in some cases. In the case where a lithium deposit grows to reach a surface of the positive electrode 101, the positive electrode 101 and the negative electrode 102 might be short-circuited. In the end portions of the positive electrode 101 and the negative electrode 102, electric-field intensity is high and thus, a lithium deposit easily grows.

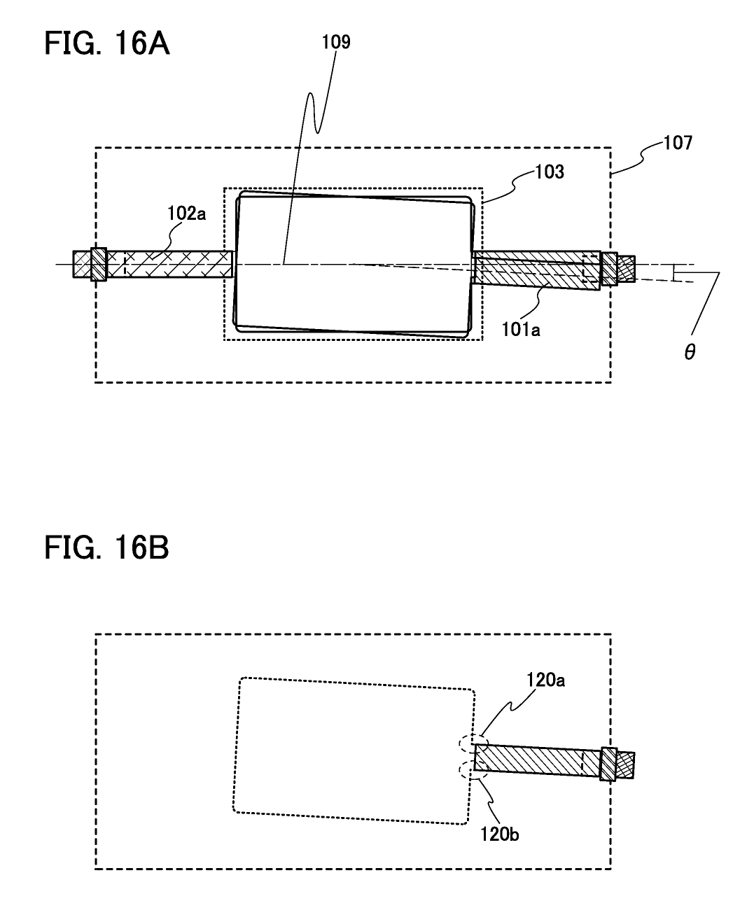

FIGS. 16A and 16B are top views of the power storage device 100. In the case where the tab region 121 is bonded to a wiring such as a lead electrode in a state where the positive electrode 101 is deviated from a midline 109 of the exterior body 107 by θ as illustrated in FIG. 16A, stress due to external force applied to change the form of the power storage device 100 is focused on bases 120a and 120b of the tab region 121 and their peripheral portions in FIG. 16B. Here, the midline of the exterior body is, for example, a midline in a top view of the exterior body as shown in FIG. 16A. The angle of the positive electrode 101 with respect to the midline 109 of the exterior body 107 is an angle between the midline of the positive electrode 101 and the midline of the exterior body 107, for example. Furthermore, tensile stress might be caused on the base 120a and compressive stress might be caused on the base 120b, for example. The stress easily results in a crack in the bases 120a and 120b and their peripheral portions when the power storage device 100 is repeatedly changed in form. Note that in FIG. 16B, the separator 103, the negative electrode 102, and the like are omitted for easy understanding. The above description of the positive electrode 101 also applies to the negative electrode 102.

One embodiment of the present invention makes it possible to reduce misalignment between the positive electrode 101 and the negative electrode 102 and increase the capacity. A reduction in misalignment can reduce the area where the positive electrode 101 and the negative electrode 102 do not overlap with each other. One embodiment of the present invention makes it possible to reduce the angle between the central axis of the exterior body and the central axis of the electrode to increase reliability.

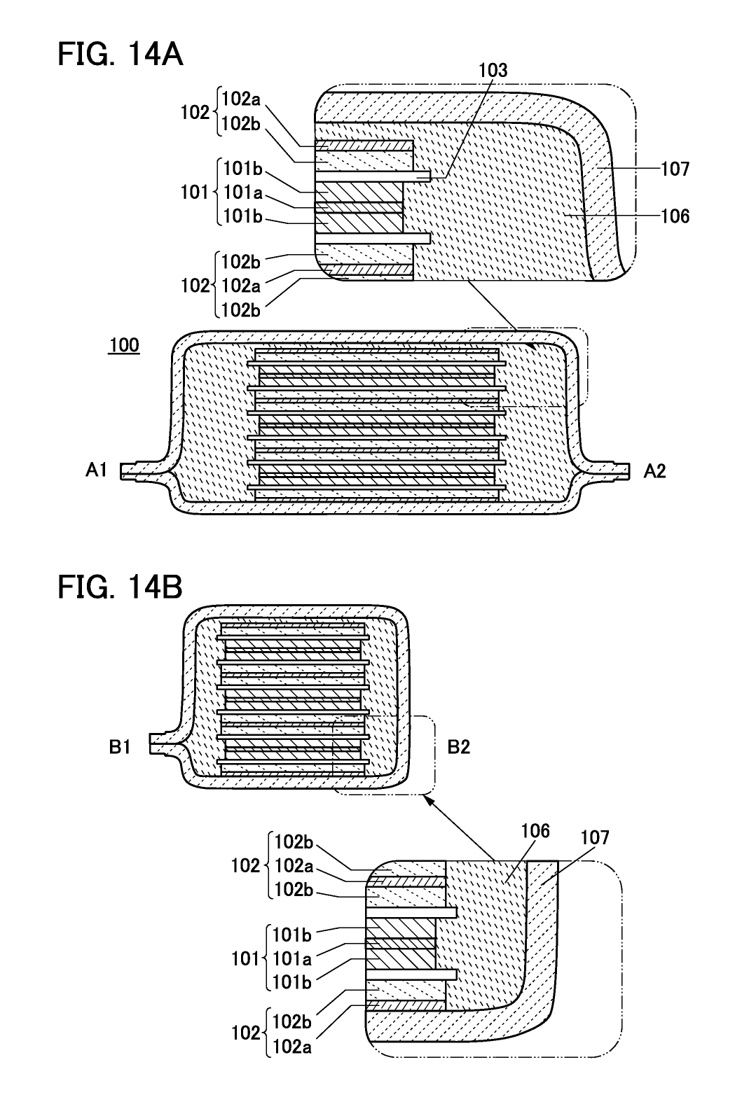

FIGS. 14A and 14B show cross-sectional views of the power storage device 100 different from those in FIGS. 2A and 2B. As illustrated in FIGS. 14A and 14B, the negative electrode 102 may be larger than the positive electrode 101 so that a margin is left, in which case the end portion of the negative electrode 102 is positioned so as not to overlap with the positive electrode 101. When the end portion of the negative electrode 102 does not overlap with the positive electrode 101, short-circuit due to a deposit or the like is inhibited, whereby the reliability of the power storage device 100 can be improved. Also in the case of such a structure, one embodiment of the present invention can be employed to reduce misalignment between the positive electrode 101 and the negative electrode 102; accordingly, an overlap between the end portion of the negative electrode and the positive electrode can be inhibited. As a result, the capacity of the power storage device 100 can be increased.

### [1. Positive Electrode]

In FIGS. 2A and 2B, the positive electrode 101 includes the positive electrode current collector 101a, the positive electrode active material layer 101b in contact with the positive electrode current collector 101a, and the like. The positive electrode active material layer 101b may be provided on one or both surfaces of the positive electrode current collector 101a. Providing the positive electrode active material layer 101b on both surfaces of the positive electrode current collector 101a allows the power storage device 100 to have high capacity. When the active material layer is provided on both surfaces, the weight ratio and volume ratio of the active material to the current collector can be increased. Thus, the capacity per weight and the capacity per volume of the power storage device 100 can be increased. The positive electrode active material layer 101b may be provided on the entire positive electrode current collector 101a or part of the positive electrode current collector 101a. For example, it is preferable that the positive electrode active material layer 101b not be provided in a portion where the positive electrode current collector 101a and the positive electrode lead 104 are electrically connected to each other and a portion where the positive electrode current collectors 101a are electrically connected to each other.

The positive electrode current collector 101a can be formed using a material having high conductivity such as a metal like gold, platinum, aluminum, titanium, or manganese, or an alloy thereof (e.g., stainless steel). Alternatively, an aluminum alloy to which an element which improves heat resistance, such as silicon, neodymium, scandium, or molybdenum, is added can be used. The positive electrode current collector 101a can have a foil-like shape, a plate-like shape (sheet-like shape), a net-like shape, a punching-metal shape, or the like as appropriate. The positive electrode current collector 101a preferably has a thickness greater than or equal to 5 μm and less than or equal to 30 μm. The surface of the positive electrode current collector 101a may be provided with an undercoat using graphite or the like.

The positive electrode active material layer 101b may include a binder for increasing adhesion of positive electrode active materials, a conductive additive for increasing the conductivity of the positive electrode active material layer 101b, and the like in addition to the positive electrode active material.

Examples of the positive electrode active material used for the positive electrode active material layer 101b include a composite oxide with an olivine crystal structure, a composite oxide with a layered rock-salt crystal structure, and a composite oxide with a spinel crystal structure. As the positive electrode active material, a compound such as LiFeO₂, LiCoO₂, LiNiO₂, LiMn₂O₄, V₂O₅, Cr₂O₅, and MnO₂ is used.

LiCoO₂ is particularly preferable because it has higher capacity, higher stability in the air and higher thermal stability than LiNiO₂, for example.

It is preferable to add a small amount of lithium nickel oxide (LiNiO₂ or LiNi₁₋ₓMO₂ (M=Co, Al, or the like)) to a lithium-containing material with a spinel crystal structure which contains manganese such as LiMn₂O₄ because the elution of manganese and the decomposition of an electrolyte solution can be suppressed, for example.

Alternatively, a complex material (LiMPO₄ (general formula) (M is one or more of Fe(II), Mn(II), Co(II), and Ni(II))) can be used. As typical examples, lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1) can be used.

LiFePO₄ is particularly preferable because it possesses well-balanced properties as the positive electrode active material of a power storage device with safety, stability, high capacity density, high potential, and the like due to a large amount of lithium ions which can be extracted in initial oxidation (charging).

Alternatively, a complex material such as Li₍₂₋ⱼ₎MSiO₄ (general formula) (M is one or more of Fe(II), Mn(II), Co(II), and Ni(II); 0≦j≦2) may be used. Typical examples of the general formula Li₍₂₋ⱼ₎MSiO₄ are Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q 1, 0<m<1, 0<n<1, and 0<q<1), Li₍₂₋ⱼ₎FeᵣNiₛCoₜMnᵤSiO₄ (r+s+t+u≦1, 0<r<1, 0<s<1, 0<t<1, and 0<u<1), and the like.

Still alternatively, a nasicon compound expressed by AₓM₂(XO₄)₃ (general formula) (A=Li, Na, or Mg, M=Fe, Mn, Ti, V, Nb, or Al, X=S, P, Mo, W, As, or Si) can be used as the positive electrode active material. Examples of the nasicon compound are Fe₂(MnO₄)₃, Fe₂(SO₄)₃, and Li₃Fe₂(PO₄)₃. Still further alternatively, compounds represented by a general formula, Li₂MPO₄F, Li₂MP₂O₇, and Li₅MO₄ (M=Fe or Mn), a perovskite fluoride such as NaFeF₃ and FeF₃, a metal chalcogenide (a sulfide, a selenide, and a telluride) such as TiS₂ and MoS₂, an oxide with an inverse spinel crystal structure such as LiMVO₄, a vanadium oxide (e.g., V₂O₅, V₆O₁₃, and LiV₃O₈), a manganese oxide, and organic sulfur can be used as the positive electrode active material, for example.

In the case where carrier ions are alkali metal ions other than lithium ions or alkaline-earth metal ions, the following may be used as the positive electrode active material: an alkali metal (e.g., sodium or potassium) or an alkaline-earth metal (e.g., calcium, strontium, barium, beryllium, or magnesium). For example, the positive electrode active material may be a layered oxide containing sodium such as NaFeO₂ or Na_{2/3}[Fe_{1/2}Mn_{1/2}]O₂.

Further alternatively, any of the aforementioned materials may be combined to be used as the positive electrode active material. For example, the positive electrode active material may be a solid solution containing any of the aforementioned materials, e.g., a solid solution containing LiCo_{1/3}Mn_{1/3}Ni_{1/3}O₂ and Li₂MnO₃.

Although not illustrated, a carbon layer or an oxide layer such as a zirconium oxide layer may be provided on a surface of the positive electrode active material layer 101b. The carbon layer or the oxide layer increases the conductivity of an electrode. The positive electrode active material layer 101b can be coated with the carbon layer by mixing a carbohydrate such as glucose at the time of baking the positive electrode active material.

The average particle diameter of the primary particle of the positive electrode active material layer 101b is preferably greater than or equal to 50 nm and less than or equal to 100 μm.

Examples of the conductive additive include acetylene black (AB), graphite (black lead) particles, carbon nanotubes, graphene, and fullerene.

A network for electron conduction can be formed in the positive electrode 101 by the conductive additive. The conductive additive also allows maintaining of a path for electric conduction in the positive electrode active material layer 101b. The addition of the conductive additive to the positive electrode active material layer 101b increases the electron conductivity of the positive electrode active material layer 101b.

Flaky graphene has an excellent electrical characteristic of high conductivity and excellent physical properties of high flexibility and high mechanical strength. For this reason, the use of graphene as the conductive additive can increase the points and the area where the positive electrode active material particles are in contact with each other.

Note that graphene in this specification includes single-layer graphene and multilayer graphene including 2 or more and 100 or less layers. Single-layer graphene refers to a one-atom-thick sheet of carbon molecules having π bonds. Graphene oxide refers to a compound formed by oxidation of such graphene. When graphene oxide is reduced to graphene, oxygen contained in the graphene oxide is not entirely released and part of the oxygen remains in the graphene. In the case where graphene contains oxygen, the proportion of the oxygen measured by X-ray photoelectron spectroscopy (XPS) is 2% or more and 20% or less, preferably 3% or more and 15% or less of the whole graphene.

As the binder, instead of poly(vinylidene fluoride) (PVdF) as a typical one, a polyimide, polytetrafluoroethylene, poly(vinyl chloride), an ethylene-propylene-diene copolymer, styrene-butadiene rubber, acrylonitrile-butadiene rubber, fluorine rubber, poly(vinyl acetate), poly(methyl methacrylate), polyethylene, nitrocellulose, or the like can be used.

The content of the binder in the positive electrode active material layer 101b is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the positive electrode active material layer 101b is preferably greater than or equal to 1 wt % and less than or equal to 10 wt %, more preferably greater than or equal to 1 wt % and less than or equal to 5 wt %.

In the case where the positive electrode active material layer 101b is formed by a coating method, the positive electrode active material, the binder, and the conductive additive are mixed to form a positive electrode paste (slurry), and the positive electrode paste is applied to the positive electrode current collector 101a and baked.

### [2. Negative Electrode]

The negative electrode 102 includes, for example, a negative electrode current collector 102a and a negative electrode active material layer 102b formed over the negative electrode current collector 102a. In this embodiment, the negative electrode active material layer 102b is not provided in a portion where the tab region of the negative electrode 102 electrically contacts to the negative electrode lead 105.

The negative electrode current collector 102a can be formed using a material that has a high conductivity and is not alloyed with a metal of a carrier ion such as lithium ion, e.g., a metal such as gold, platinum, iron, copper, titanium, tantalum, or manganese, or an alloy thereof (e.g., stainless steel). Alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The negative electrode current collector 102a can have a foil-like shape, a plate-like shape (sheet-like shape), a net-like shape, a punching-metal shape, or the like as appropriate. The negative electrode current collector 102a preferably has a thickness greater than or equal to 5 μm and less than or equal to 30 μm. The surface of the negative electrode current collector 102a may be provided with an undercoat using graphite or the like.

The negative electrode active material layer 102b may include a binder for increasing adhesion of negative electrode active materials, a conductive additive for increasing the conductivity of the negative electrode active material layer 102b, and the like in addition to the negative electrode active materials.

There is no particular limitation on the negative electrode active material as long as it is a material with which lithium can be dissolved and precipitated or a material into/from which lithium ions can be inserted and extracted. Other than a lithium metal or lithium titanate, a carbon-based material generally used in the field of power storage, or an alloy-based material can also be used as the negative electrode active material.

The lithium metal is preferable because of its low redox potential (which is lower than that of the standard hydrogen electrode by 3.045 V) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (approximately 0.1 V to 0.3 V vs. Li/Li⁺) when lithium ions are intercalated into the graphite (when a lithium-graphite intercalation compound is formed). For this reason, a lithium ion battery can have a high operating voltage. In addition, graphite is preferable because of its advantages such as relatively high capacity per unit volume, small volume expansion, low cost, and safety greater than that of a lithium metal.

For the negative electrode active material, an alloy-based material or oxide which enables charge-discharge reaction by an alloying reaction and a dealloying reaction with lithium can be used. In the case where lithium ions are carrier ions, the alloy-based material is, for example, a material containing at least one of Al, Si, Ge, Sn, Pb, Sb, Bi, Ag, Zn, Cd, In, Ga, and the like. Such elements have higher capacity than carbon. In particular, silicon has a theoretical capacity of 4200 mAh/g, which is significantly high. For this reason, silicon is preferably used as the negative electrode active material. Examples of the alloy-based material using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, as the negative electrode active material, oxide such as SiO, SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), molybdenum oxide (MoO₂), or the like can be used.

Still alternatively, as the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material which does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Still further alternatively, as the negative electrode active material, a material which causes conversion reaction can be used. For example, a transition metal oxide which does not give an alloy with lithium, such as cobalt oxide (CoO), nickel oxide (NiO), or iron oxide (FeO), may be used for the negative electrode active material. Other examples of the material which undergoes a conversion reaction include oxides such as Fe₂O₃, CuO, Cu₂O, RuO₂, and Cr₂O₃, sulfides such as CoS_{0.89}, NiS, or CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as the positive electrode active material because of its high potential.

In the case where the negative electrode active material layer 102b is formed by a coating method, the negative electrode active material and the binder are mixed to form a negative electrode paste (slurry), and the negative electrode paste is applied to the negative electrode current collector 102a and baked. Note that a conductive additive may be added to the negative electrode paste.

Graphene may be formed on a surface of the negative electrode active material layer 102b. For example, in the case of using silicon as the negative electrode active material layer 102b, the volume of silicon is greatly changed because of occlusion and release of carrier ions in charge-discharge cycles. Thus, adhesion between the negative electrode current collector 102a and the negative electrode active material layer 102b is decreased, resulting in degradation of battery characteristics caused by charge and discharge. Thus, graphene is preferably formed on a surface of the negative electrode active material layer 102b containing silicon because even when the volume of silicon is changed in charge-discharge cycles, decrease in the adhesion between the negative electrode current collector 102a and the negative electrode active material layer 102b can be inhibited, which makes it possible to reduce degradation of battery characteristics.

### [3. Separator]

An electrolyte solution can pass through the separator 103. The separator 103 has openings (or pores) through which an electrolyte solution passes. As a material of the separator 103, a porous insulator such as cellulose, polypropylene (PP), polyethylene (PE), polybutene, a polyamide, a polyester, a polysulfone, polyacrylonitrile, poly(vinylidene fluoride), or polytetrafluoroethylene can be used. Alternatively, nonwoven fabric of a glass fiber or the like, or a film in which a glass fiber and a polymer fiber are mixed may be used.

### [4. Electrolyte Solution]

As a solvent of the electrolyte solution 106 used for the power storage device 100, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When a gelled high-molecular material is used as the solvent for the electrolyte solution, safety against liquid leakage and the like is improved. Furthermore, a secondary battery can be thinner and more lightweight. Typical examples of the gelled high-molecular material include a silicone gel, an acrylic gel, an acrylonitrile gel, a poly(ethylene oxide)-based gel, a polypropylene oxide)-based gel, a gel of a fluorine-based polymer, and the like.

Alternatively, the use of one or more kinds of ionic liquids (room temperature molten salts) which have features of non-flammability and non-volatility as a solvent of the electrolyte solution can prevent the power storage device from exploding or catching fire even when the power storage device internally shorts out or the internal temperature increases because of overcharging and others. An ionic liquid includes a cation and an anion, specifically, an organic cation and an anion. Examples of the organic cation used for the electrolyte solution are aliphatic onium cations, such as a quaternary ammonium cation, a tertiary sulfonium cation, and a quaternary phosphonium cation, and aromatic cations, such as an imidazolium cation and a pyridinium cation. Examples of the anion used for the electrolyte solution are a monovalent amide anion, a monovalent methide anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

In the case of using a lithium ion as a carrier ion, as an electrolyte dissolved in the above-described solvent, one of lithium salts such as LiPF₆, LiClO₄, LiAsF₆, LiBF₄, LiAlCl₄, LiSCN, LiBr, La, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination in an appropriate ratio.

The electrolyte solution used for the power storage device is preferably a highly purified one so as to contain a negligible amount of dust particles and elements other than the constituent elements of the electrolyte solution (hereinafter, also simply referred to as impurities). Specifically, the weight ratio of impurities to the electrolyte solution is less than or equal to 1%, preferably less than or equal to 0.1%, and more preferably less than or equal to 0.01%.

### [5. Exterior Body]

The secondary battery can have any of a variety of structures. In this embodiment, a film is used for the exterior body 107. Note that the film used for the exterior body 107 is a single-layer film selected from a metal film (e.g., an aluminum film, a stainless steel film, and a nickel steel film), a plastic film made of an organic material, a hybrid material film including an organic material (e.g., an organic resin or fiber) and an inorganic material (e.g., ceramic), and a carbon-containing inorganic film (e.g., a carbon film or a graphite film); or a stacked-layer film including two or more of the above films. When a metal film is used, the metal film preferably has the following three-layered structure, for example, to insulate the surfaces: an inner coat is provided to one surface of the metal film by using polyethylene, polypropylene, a polycarbonate, an ionomer, a polyamide, or the like, and an outer coat is provided to the other surface of the metal film by using a film of an insulating synthesis resin such as a polyamide resin or a polyester resin. The exterior body 107 can be sealed using heat, for example.

The depressions or projections may be formed on the exterior body 107 by pressing, e.g., embossing. A metal film is easily embossed. Forming a depression or a projection on a surface of a metal film by embossing increases the surface area of the exterior body 107 exposed to outside air, achieving efficient heat dissipations.

In the case where the power storage device 100 is deformed by externally applying force, the exterior body 107 might be damaged. The depression or projection formed on the surface of the exterior body 107 can relieve a strain caused by stress applied to the exterior body 107. Therefore, the power storage device 100 can have high reliability. Note that a “strain” is the scale of change in form indicating the displacement of a point of an object relative to the reference (initial) length of the object. The depression or the projection formed on the surface of the exterior body 107 can reduce the influence of a strain to an acceptable level. Thus, the power storage device having high reliability can be provided.

This embodiment can be implemented in combination with any of the other embodiments as appropriate.

### Embodiment 2

In this embodiment, an example of a manufacturing method of the power storage device 100 is described with reference to drawings.

### [1. Alignment of Electrode]

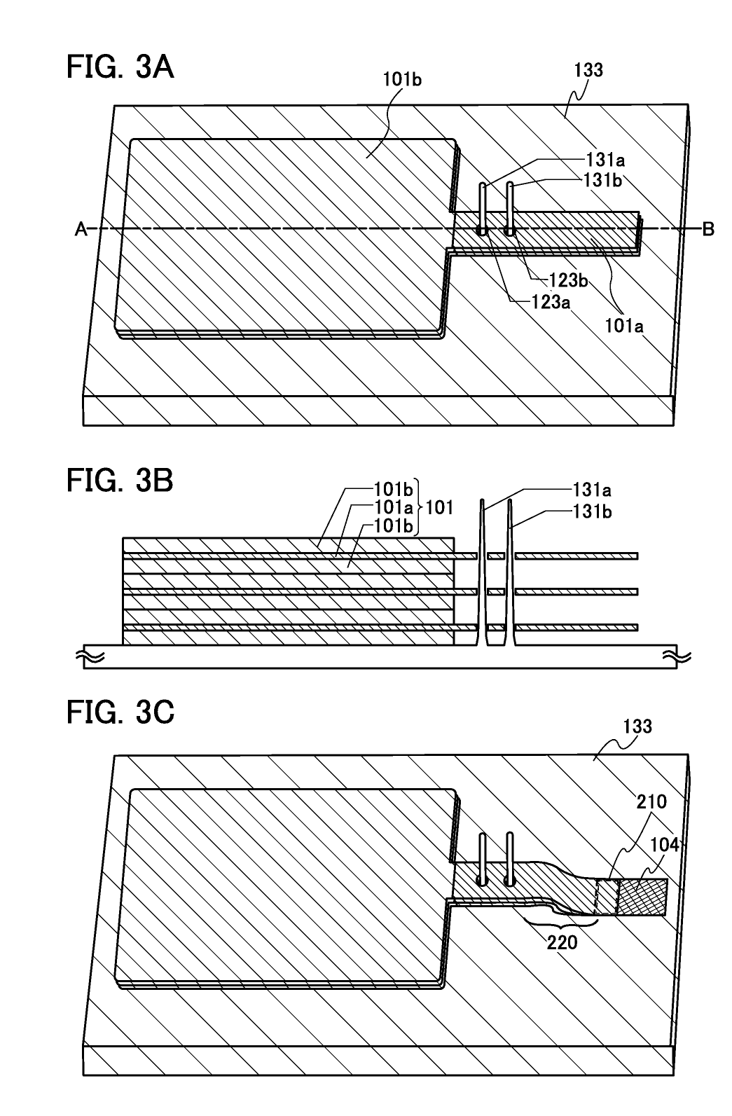

As shown in FIG. 3B, the positive electrodes 101 are stacked. The positive electrodes 101 each include the positive electrode current collector 101a and the positive electrode active material layer 101b provided on at least one surface of the positive electrode current collector 101a. The positive electrodes 101 in FIG. 3A each have the holes 123a and 123b, and the two holes are arranged along a midline of the positive electrode 101 shown by a dashed line A-B. In the case where the positive electrode 101 is formed by molding, for example, the holes 123a and 123b may be formed in the positive electrode 101 during or after the molding. The holes 123a and 123b may have different sizes and shapes. When a plurality of holes, which are not limited to the holes 123a and 123b, are provided in the positive electrode 101, the holes may have different sizes and shapes. Difference in size between the plurality of holes facilitates determination of the direction and automatization, for example. The plurality of holes are not necessarily spaced uniformly or arranged in one direction. The shape or size of the hole may be different between the positive electrodes 101. Note that the above description referring to the positive electrode 101 also applies to the negative electrode 102 having holes. In the positive electrode 101, the holes are preferably provided in the tab region 121 of the positive electrode. In the negative electrode 102, the holes are preferably provided in the tab region of the negative electrode.

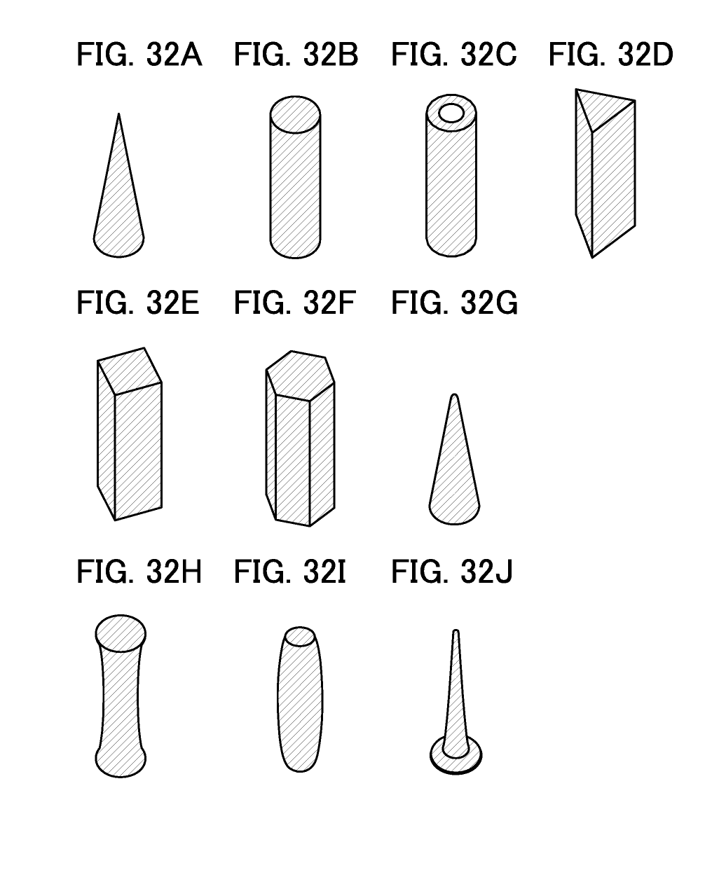

A pin 131a and a pin 131b are provided on a stage 133. FIG. 3B shows a cross section of the plurality of positive electrodes 101, which is taken along a dashed-dotted line A-B in FIG. 3A. Alignment of the holes 123a and 123b by the pins 131a and 131b can minimize misalignment at the time of stacking the plurality of positive electrodes 101. There is no particular limitation on the number of the stacked positive electrodes. For example, 2 to 80 positive electrodes can be stacked. Furthermore, although the pins 131a and 131b are provided on the stage 133, such a stage is not necessarily used. The pins 131a and 131b may have any of various shapes. Examples of the shapes of the pins 131a and 131b are illustrated in perspective views of FIGS. 32A to 32J. The pins 131a and 131b may each have a conical shape as illustrated in FIG. 32A, or a cylindrical shape as illustrated in FIG. 32B. A conical or pyramidal pin can be easily put through the hole because of its tip much smaller than the hole. In addition, such a conical or pyramidal pin can reduce misalignment because of its lower part allowing only a narrow gap with the edge of the hole. The pin may have a hollow as illustrated in FIG. 32C or may have a prismatic shape as illustrated in FIGS. 32D, 32E, and 32F. A conical shape whose tip is rounded, as illustrated in FIG. 32G, may also be employed. Alternatively, a columnar shape to which a concave curve or a convex curve is given as illustrated in FIG. 32H or FIG. 32I may be employed. A shape in which an angle between the bottom surface and the side surface continuously changes as illustrated in FIG. 32J can also be employed. Since the diameter of the upper portion is smaller than that of the lower portion, a pin having this shape reduces misalignment as a conical or pyramidal pin does. The pins 131a and 131b may have the same shape or different shapes. The pins 131a and 131b may have different sizes, diameters, or heights, for example. Note that the shapes of the pins 131a and 131b are not limited to those illustrated in FIGS. 32A to 32J.

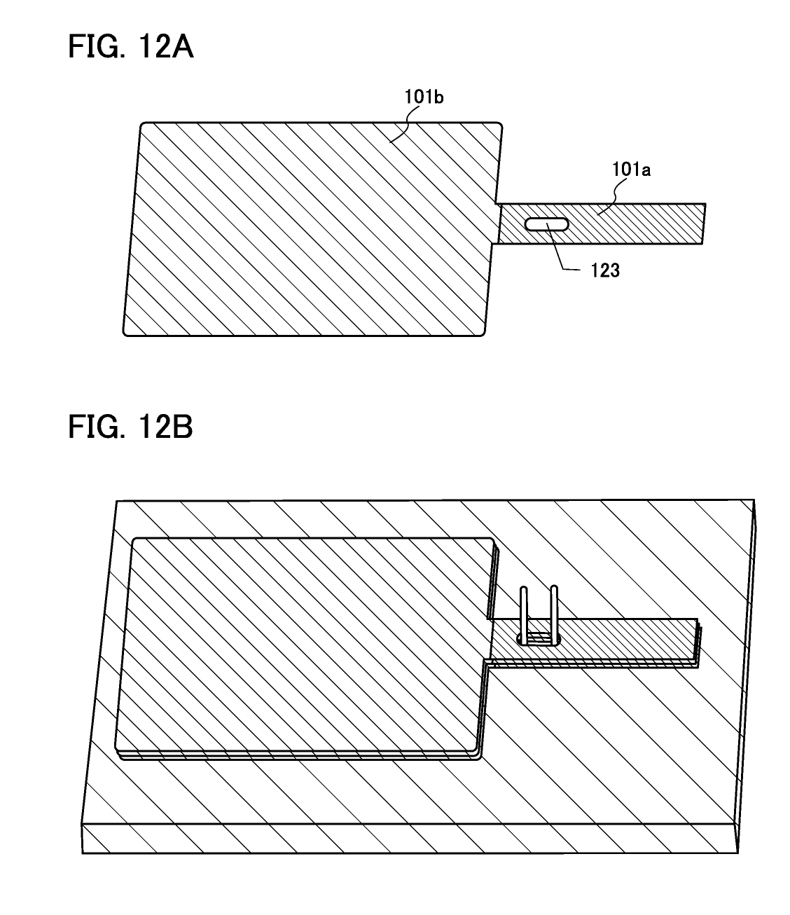

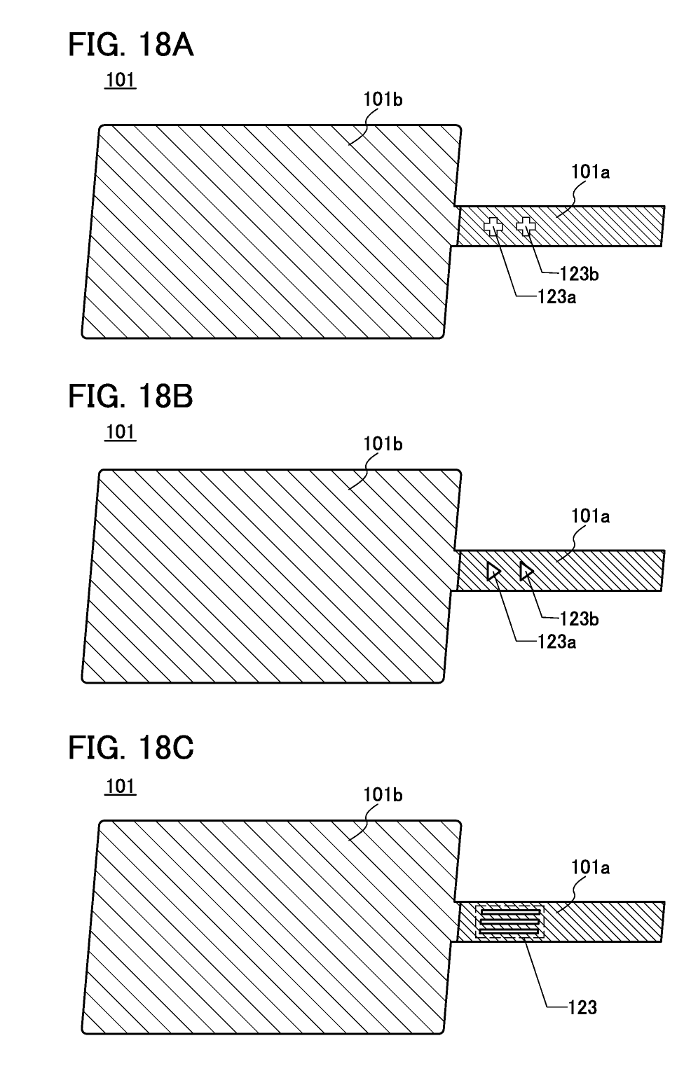

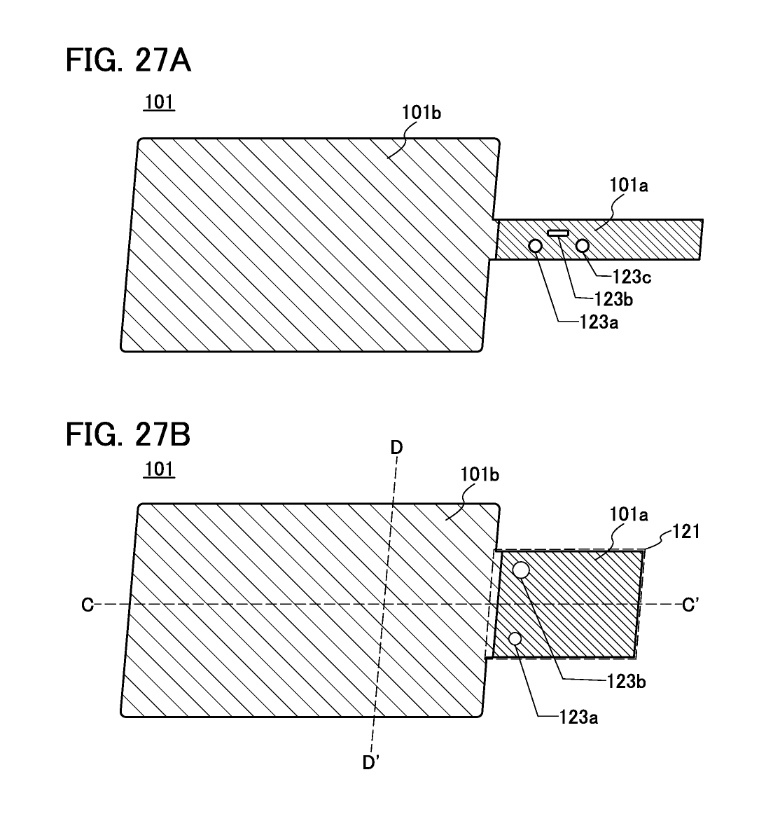

Next, the tab regions 121 of the plurality of positive electrodes 101 and the positive electrode lead 104 are electrically connected in a bonding portion 210 by application of ultrasonic waves and pressure (ultrasonic welding). The welding is performed in a state where the positions of the positive electrodes are fixed with the pins, by which the positive electrodes can be stacked maintaining their positions. Although FIGS. 3A to 3C illustrate an example in which the positive electrodes 101 each have two holes, the number of the holes is not limited thereto. For example, one hole may be provided or three or more holes may be arranged along the midline of the electrode. Instead of a plurality of holes, a slit 123 may be provided as illustrated in FIG. 12A. FIG. 12A is a perspective view of the positive electrode 101. The slit 123 may be rectangular or elliptical, for example. The corners of the slit may be rounded. When such a horizontally long slit is provided, one slit may be fixed using two pins as illustrated in FIG. 12B, for example. The holes for alignment may have a cross shape as illustrated in FIG. 18A or a triangular shape as illustrated in FIG. 18B. Alternatively, the plurality of slits 123 may be arranged in the width direction of the tab region as illustrated in FIG. 18C. At least one of the plurality of slits is used for alignment. In the case where the plurality of slits 123 are provided, the tab region 121 can be easily bent, which facilitates stress relief when external force is applied to the power storage device. In addition, this structure can increase the resistance of the tab region 121 to repetitive bending. FIG. 27A illustrates an example in which the positive electrode 101 has the hole 123a, the hole 123b, and a hole 123c. The holes are not necessarily arranged along the midline of the positive electrode 101, and may be staggered as illustrated in FIG. 27A. As illustrated in FIG. 27B, the holes 123a and 123b may be arranged substantially parallel to a midline D-D′ which is substantially perpendicular to a midline C-C′. Note that the plurality of holes are not necessarily arranged parallel to the midline. Here, FIGS. 27A and 27B are perspective views of the positive electrode 101.

The tab region 121 and the bonding portion 122 of the tab region and the lead are easily cracked or cleaved by external force. FIG. 3C illustrates the stacked positive electrodes 101 that are bonded to the positive electrode lead 104 at the bonding portion 210. When a curved portion 220 is formed in the tab region 121 as shown in FIG. 3C, external force can be relieved. In this manner, the reliability of the power storage device 100 can be increased.

FIGS. 3A to 3C show examples in which the positive electrodes 101 are stacked, and the negative electrodes 102 can also be stacked in a similar manner. The negative electrodes 102 also have holes for alignment, as the positive electrodes do. Thus, the stacked positive electrodes 101 and the stacked negative electrodes 102 can be formed. The description of the holes and the tab region of the positive electrode 101 can be applied to the negative electrode 102.

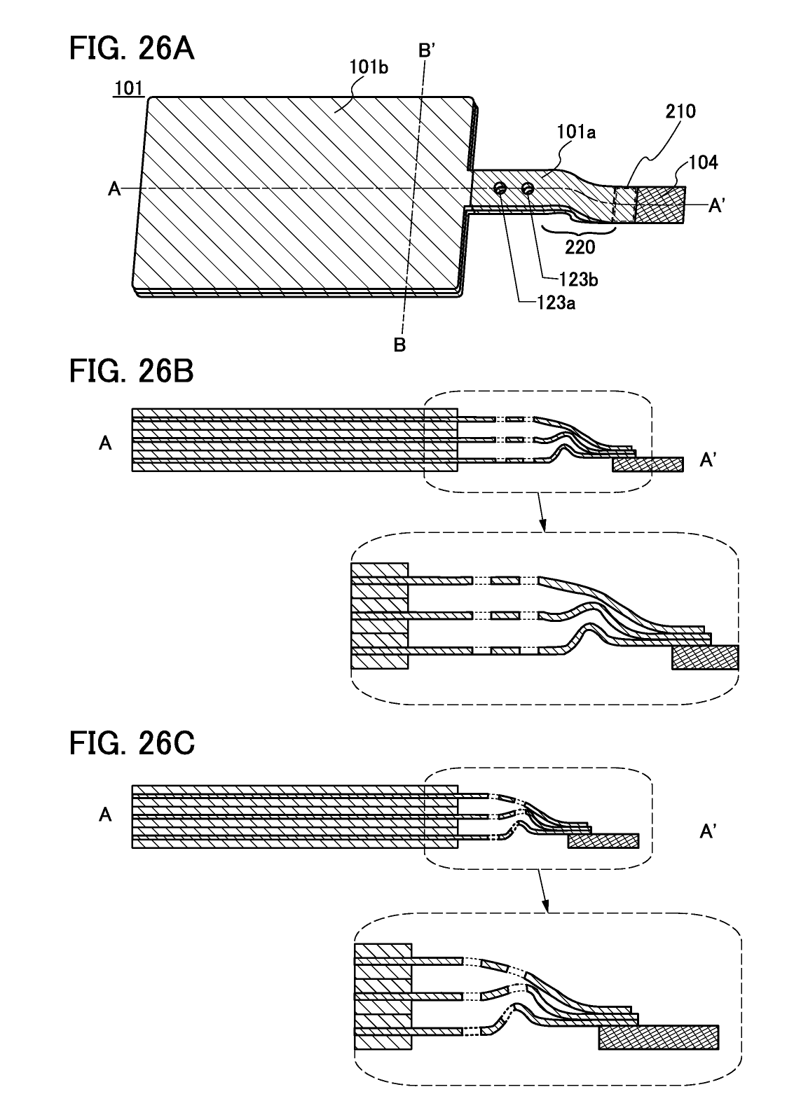

FIG. 26A is a perspective view illustrating the plurality of positive electrodes 101 that are bonded to the positive electrode lead 104 after being stacked. Here, when “the plurality of positive electrodes 101 are bonded to the positive electrode lead 104,” the bonding portion of one of the positive electrodes 101 may be in direct contact with the positive electrode lead 104 or may be in indirect contact with the positive electrode lead 104 via the bonding portion of another positive electrode provided therebetween. FIGS. 26B and 26C each show a cross section along a dashed-dotted line A-A′ in FIG. 26A. In FIG. 26B, the holes 123a of the plurality of positive electrodes 101 are almost perfectly aligned, and the holes 123b thereof are substantially aligned. By contrast, in FIG. 26C, the holes 123a of the plurality of positive electrodes 101 are substantially aligned but the holes 123b are misaligned. As described here, the holes are not necessarily aligned after bonding to the positive electrode lead 104, for example. Even when the holes 123b are misaligned, for example, misalignment of the plurality of positive electrodes 101 in the A-A′ direction in FIG. 26C is within 5 mm, within 2 mm, or within 1 mm, and misalignment in the B-B′ direction is within 3 mm, within 1 mm, or within 0.5 mm. Note that the above description of the positive electrode 101 also applies to the negative electrode 102.

As in the case of the positive electrodes, the negative electrode lead 105 is bonded to the stacked negative electrodes 102. The negative electrode lead 105 is electrically bonded to the tab regions 121 of the negative electrodes 102. The tab regions 121 of the negative electrodes 102 and the negative electrode lead 105 can be bonded in a manner similar to that of bonding of the tab regions 121 of the positive electrodes 101 and the positive electrode lead 104.

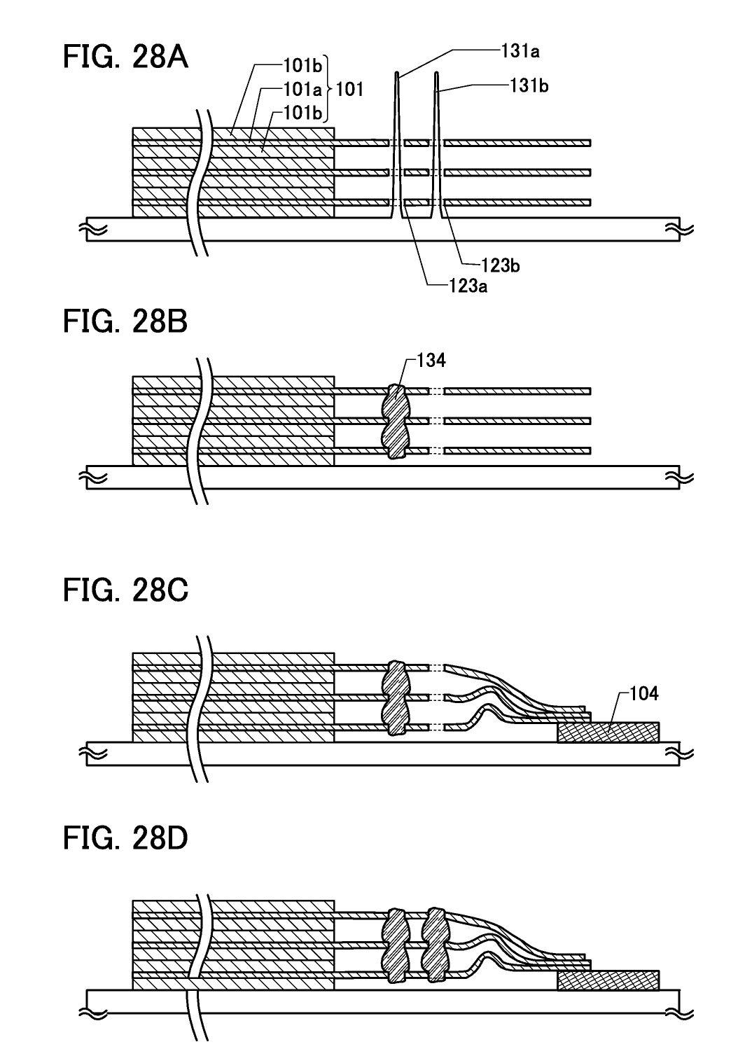

Here, after the positive electrodes 101 are stacked as shown in FIG. 28A, the holes in the positive electrodes 101 may be filled with a member 134 as shown in FIG. 28B so that the positions of the stacked electrodes are kept. The member 134 fills at least one of the plurality of holes. As illustrated in FIGS. 28C and 28D, it is also possible to connect the tab regions 121 of the positive electrodes to the positive electrode lead 104 after the positions are fixed with the use of the member 134. As the member 134, for example, a highly flexible or elastic polymer or the like can be used. For example, it is possible to use a polymer resin such as polyethylene or polypropylene. It is also possible to use natural rubber or synthesis rubber such as butadiene rubber, styrene butadiene rubber, ethylene propylene rubber, or silicone rubber. FIGS. 28A to 28D are cross-sectional views illustrating the stacked positive electrodes 101.

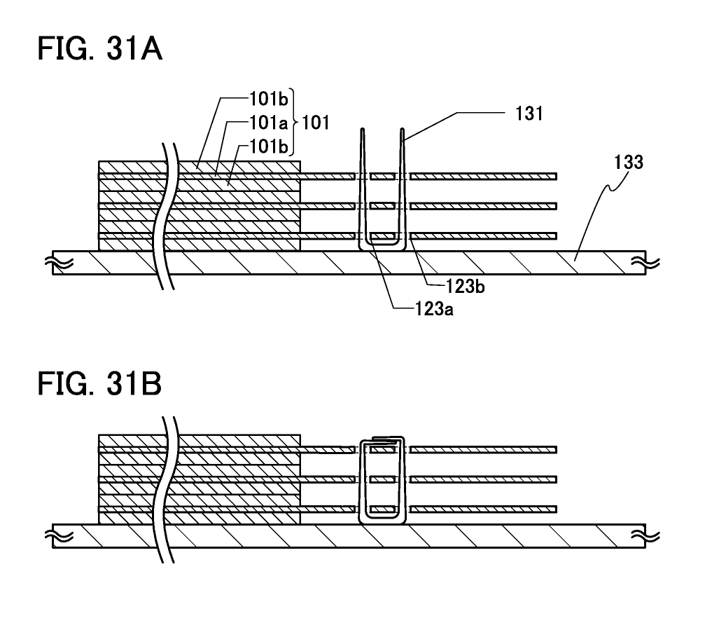

Alternatively, the plurality of positive electrodes 101 may be aligned with the use of a pin 131 as illustrated in FIG. 31A, and then, the pin 131 used for the alignment may be changed in form as illustrated in FIG. 31B to be utilized as a clasp for keeping the position. In this case, the pin 131 is preferably removable from the stage 133. The pin 131 may be changed in form by being bent or heated, for example. The upper end portions of the pin may be bent as illustrated in FIG. 31B, in which case the pin functions as a clasp of the plurality of electrodes. FIGS. 31A and 31B are cross-sectional views illustrating the stacked positive electrodes 101.

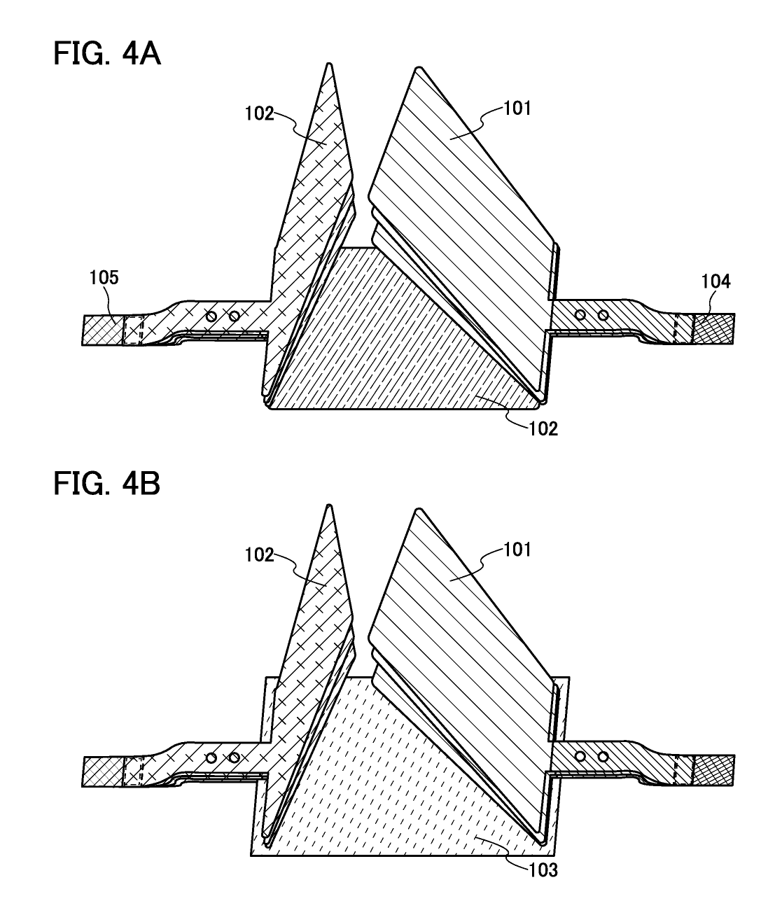

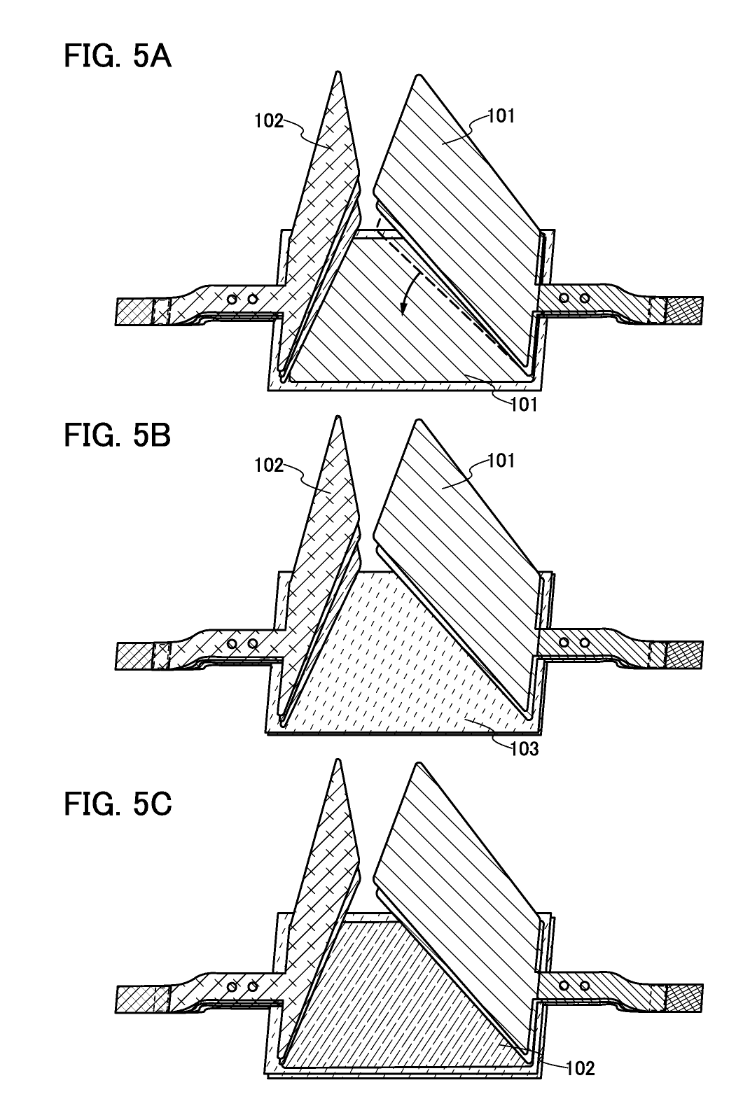

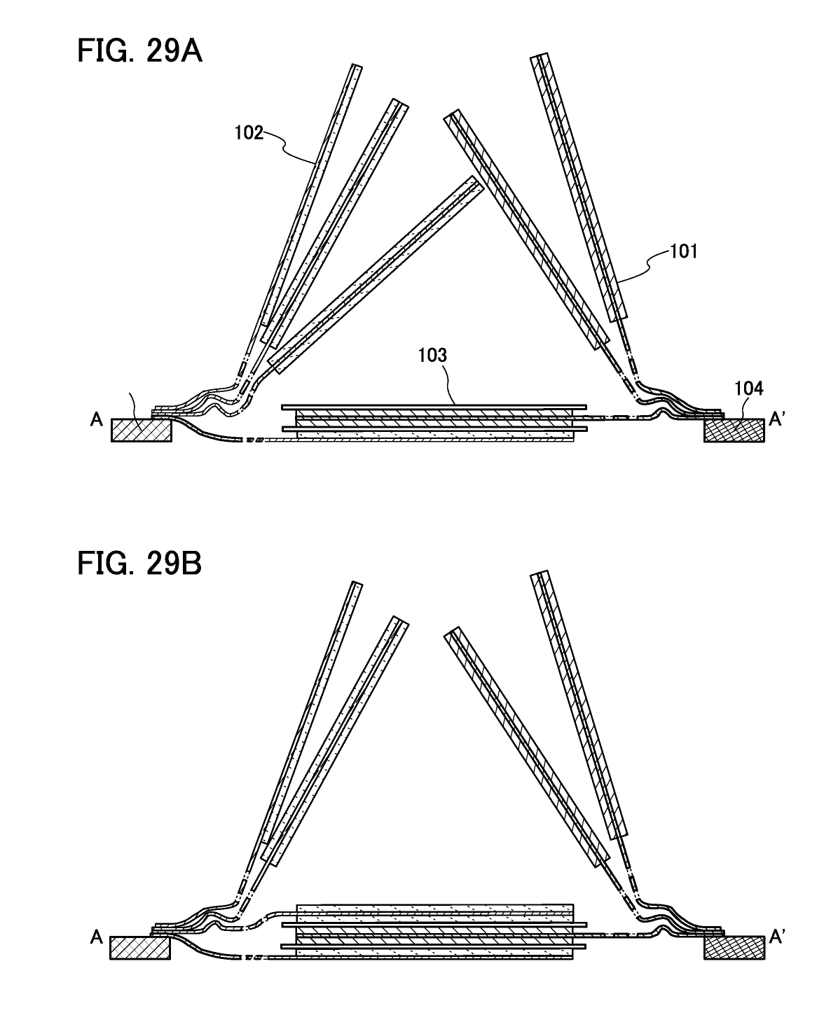

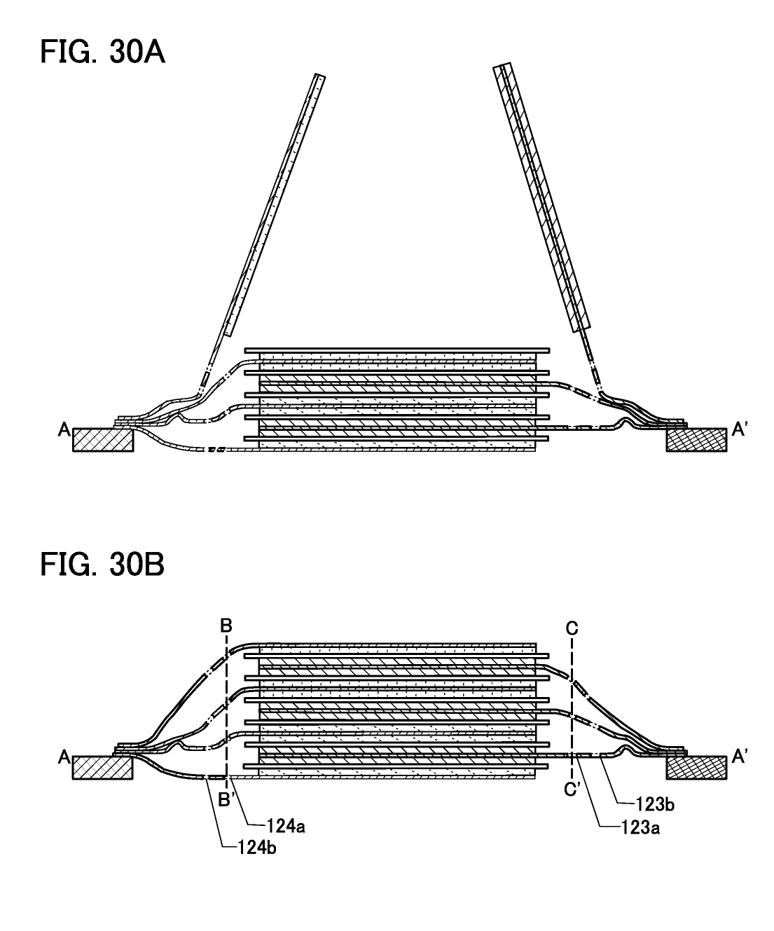

FIGS. 4A and 4B and FIGS. 5A to 5C are perspective views illustrating the negative electrodes 102 and the positive electrodes 101 that are alternately stacked. First, one of the negative electrodes 102 is laid as illustrated in FIG. 4A. Then, the separator 103 is placed over the negative electrode 102 as illustrated in FIG. 4B. After that, as illustrated in FIG. 5A, the positive electrode 101 is placed over the separator 103. The separator 103 is then placed over the positive electrode 101 as illustrated in FIG. 5B. A cross-sectional view corresponding to FIG. 5B is shown in FIG. 29A. Next, the negative electrode 102 is placed over the separator 103 as illustrated in FIG. 5C. A cross-sectional view corresponding to FIG. 5C is shown in FIG. 29B. The negative electrode 102, the separator 103, the positive electrode 101, and the separator 103 are stacked in this order repeatedly as shown in FIG. 30A; thus, the stack of the plurality of positive electrodes 101 and the plurality of negative electrodes 102 can be fabricated as illustrated in FIG. 30B. Here, when the holes 124a are aligned along a dotted line B-B′ in FIG. 30B, the plurality of negative electrodes 102 can be aligned. In a similar manner, when the holes 123a are aligned along a dotted line C-C′, the plurality of positive electrodes 101 can be aligned. To achieve the alignment of the electrodes, for example, the pins used for the alignment may be left in the portions denoted by the dotted lines B-B′ and C-C′. Alternatively, pins for keeping positions may be inserted into the portions.

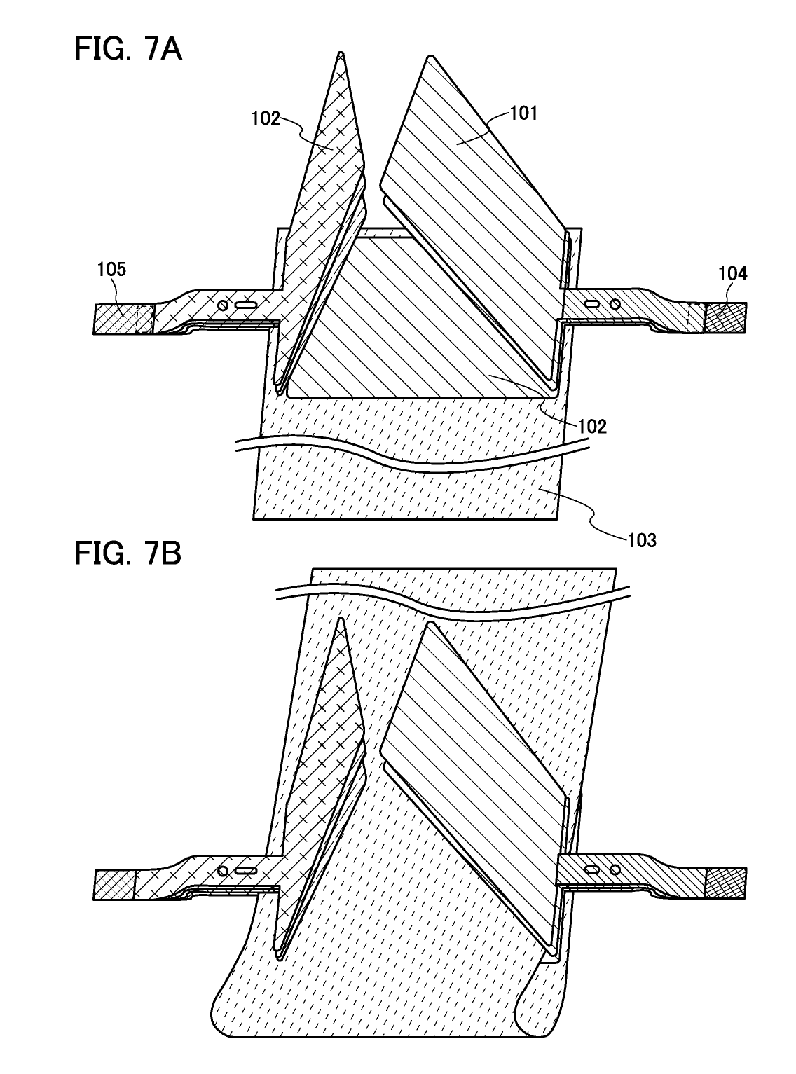

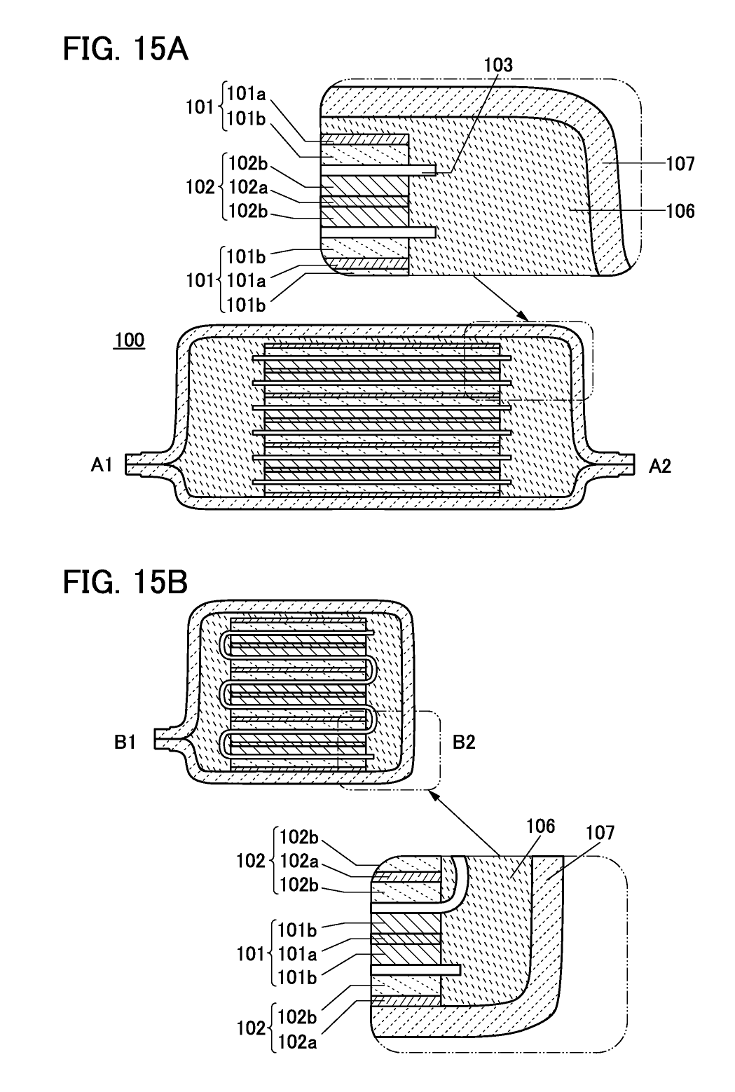

Although the sheet-shaped separators 103 are independently used in the case of FIG. 4B, a belt-shaped separator may be folded and stacked as illustrated in FIGS. 7A and 7B. FIG. 7A illustrates a state where the negative electrode 102 is laid over the belt-shaped separator 103. FIG. 7B illustrates a state where the separator 103 is folded back so as to overlap with the negative electrode 102. FIGS. 15A and 15B are cross-sectional views of the power storage device 100 manufactured by the method shown in FIGS. 7A and 7B. As can be seen in FIG. 15B, the single belt-shaped separator provided between the positive electrodes and the negative electrodes is folded. Such a structure can save the labor required for cutting a separator. Furthermore, because the separator 103 covers end portions of the positive electrode 101 and the negative electrode 102, the strength of the power storage device 100 can be increased. Here, the hole provided in the positive electrode 101 and the hole provided in the negative electrode 102 may have different sizes or shapes, for example. When the sizes or shapes of the holes are different from each other, the positive electrode 101 and the negative electrode 102 can be easily distinguished from each other, whereby the fabrication of the power storage device 100 is facilitated.

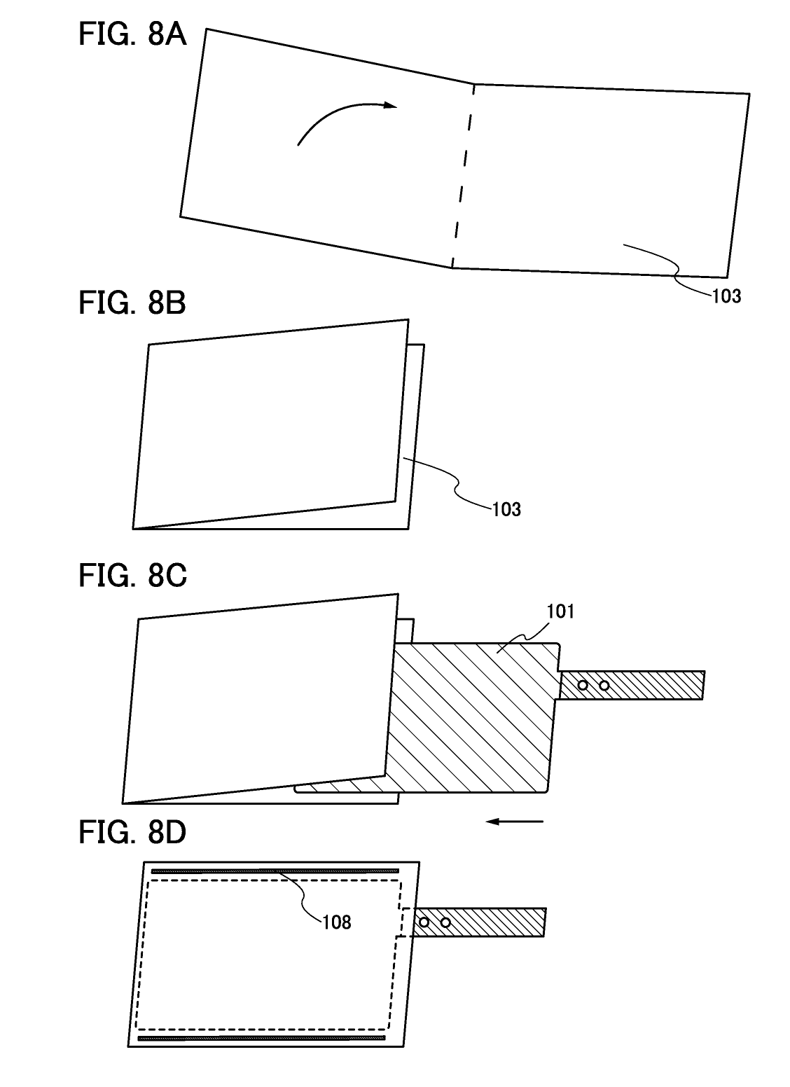

FIGS. 8A to 8D are perspective views illustrating manufacturing steps. The separator 103 may be folded along a dotted line in FIG. 8A (see FIG. 8B), and the positive electrode 101 or the negative electrode 102 may be enveloped in the separator (see FIG. 8C) and then stacked. Although FIGS. 8A to 8D illustrate an example of the positive electrode 101, the negative electrode 102 may also have this structure.

Outer edges of the folded separator 103 are preferably bonded to each other. The outer edges may be bonded to each other using an adhesive or the like or may be bonded by ultrasonic welding or thermal welding. In this embodiment, polypropylene is used as the separator 103, and the outer edges of the separator 103 are bonded to each other by heating. FIG. 8D illustrates an example of a bonding portion 108 at the outer edge of the folded separator 103. In this manner, the positive electrode 101 can be enveloped in the separator 103.

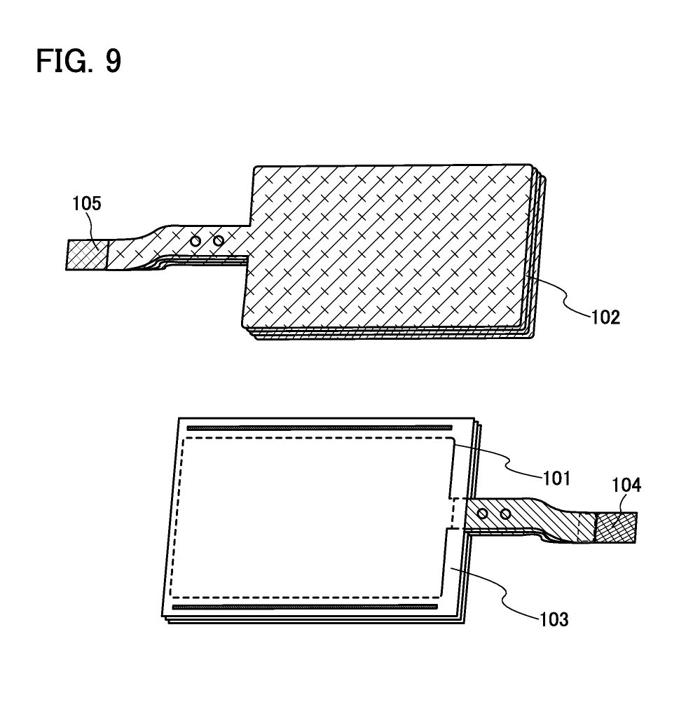

Note that the bonding portion 108 in FIG. 8D does not necessarily have a linear shape as long as the envelope shape can be retained. For example, the outer edges may be bonded to each other such that dot-shaped bonding portions are distributed. Moreover, either or both of the positive electrodes 101 and the negative electrodes 102 may be enveloped in the separators. In the perspective view of FIG. 9, the positive electrode 101 enveloped in the separator and the negative electrode 102 not enveloped are illustrated. In this manner, a structure may be employed in which only the positive electrode 101 is enveloped in the separator. The power storage device electrode can be formed by alternately stacking the enveloped positive electrode 101 and the non-enveloped negative electrode 102.

As illustrated in FIGS. 8C and 8D, the tab region may not be positioned over and along the midline but may be positioned closer to the corner than the midline is. With such a structure, the positive electrode lead 104 and the negative electrode lead 105 can be led from the same side of the exterior body 107, whereby lead wirings from terminals can be gathered and the area occupied by the wirings can be reduced; thus, the power storage device 100 can be efficiently placed in an electronic device or the like.

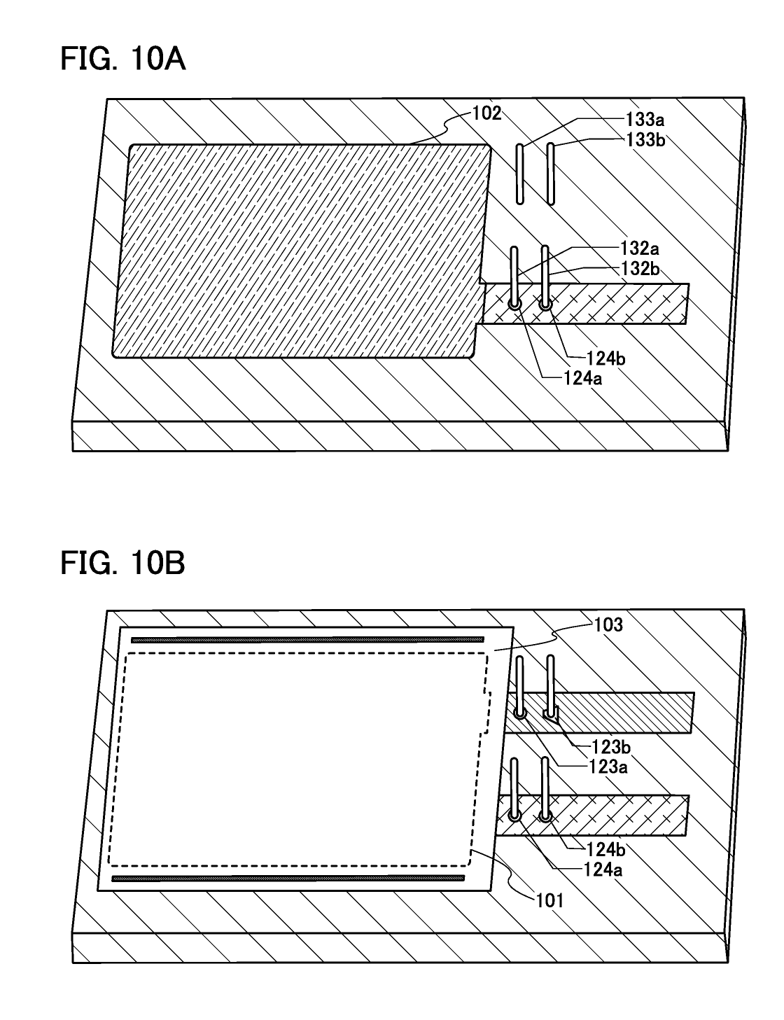

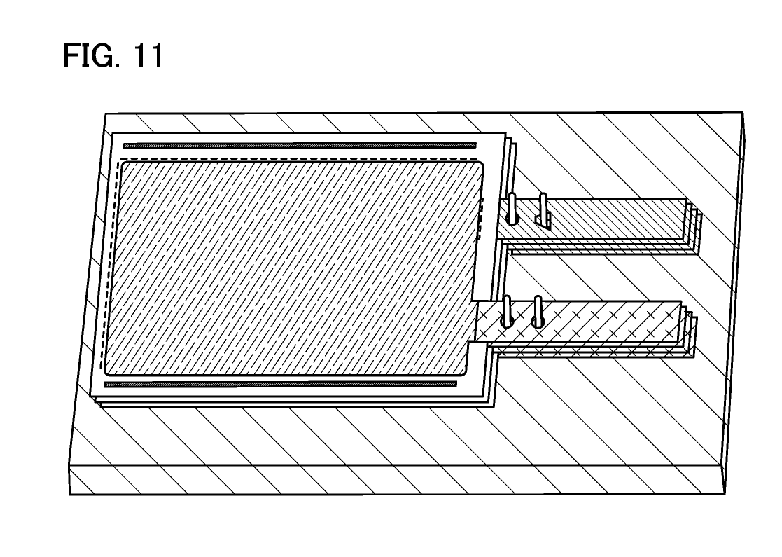

In FIGS. 4A and 4B and FIGS. 5A to 5C, the stacked positive electrodes 101 and the stacked negative electrodes 102 are formed and then the positive electrode 101 and the negative electrode 102 are alternately stacked; alternatively, as illustrated in perspective views of FIGS. 10A and 10B and FIG. 11, the negative electrode 102 and the positive electrode 101 can be alternately stacked with the use of two pairs of alignment pins: pins for aligning the negative electrodes 102 and pins for aligning the positive electrodes 101. Although an example is described here in which the positive electrode 101 enveloped in a separator and the non-enveloped negative electrode 102 are alternately stacked, it is also possible to use a sheet-shaped separator as shown in FIGS. 4A and 4B and FIGS. 5A to 5C. Alternatively, a belt-shaped separator as illustrated in FIGS. 7A and 7B may be used. The negative electrode 102 is fixed by putting alignment pins 132a and 132b through the holes 124a and 124b as shown in FIG. 10A, and then the positive electrode 101 enveloped in the separator 103 is fixed by putting alignment pins 133a and 133b through the holes 123a and 123b as shown in FIG. 10B, so that the positive electrode 101 is stacked over the negative electrode 102. When the separator 103 does not have an envelope-shape, the separator 103 may be stacked before stacking the positive electrode 101. When the negative electrode 102 and the positive electrode 101 are alternately stacked in such a manner, a power storage device electrode in which the plurality of positive electrodes 101 and the plurality of negative electrodes 102 are stacked as shown in FIG. 11 can be manufactured. The separator 103 is wider than the negative electrode 102; thus, it is difficult to align the negative electrode 102 with the use of pins or plates after the stacking. Even in this case, the use of the holes 124a and 124b and the pins 132a and 132b facilitates alignment of the negative electrodes 102.

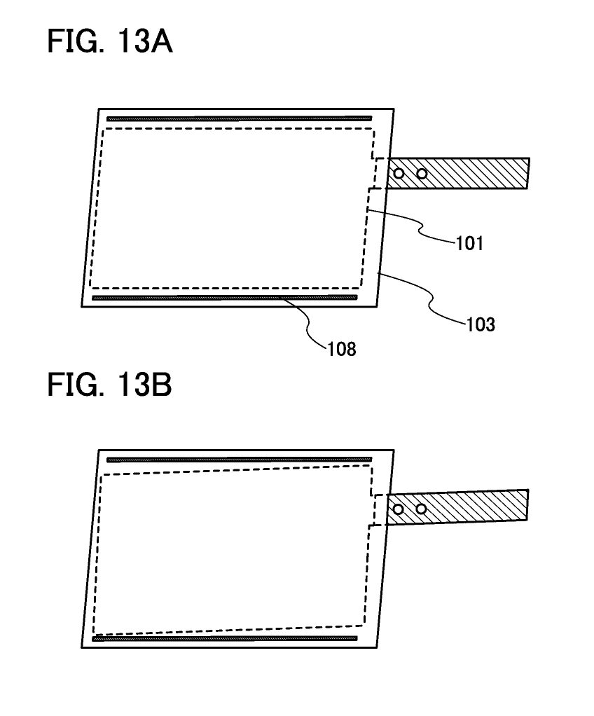

FIGS. 13A and 13B are perspective views of the positive electrode 101 enveloped in the separator 103. The positive electrode 101 in FIG. 13B is enveloped in the separator 103, but is diagonal to the end portion of the separator 103, unlike the positive electrode 101 in FIG. 13A. When these positive electrodes 101 in such two states are stacked and aligned relying on an edge of the envelope-shaped separator 103, the two positive electrodes 101 become misaligned. Even in this case, the difference in the positions of the positive electrodes 101 can be minimized when alignment is performed using the holes in the positive electrodes 101.

### [2. Exterior Body]

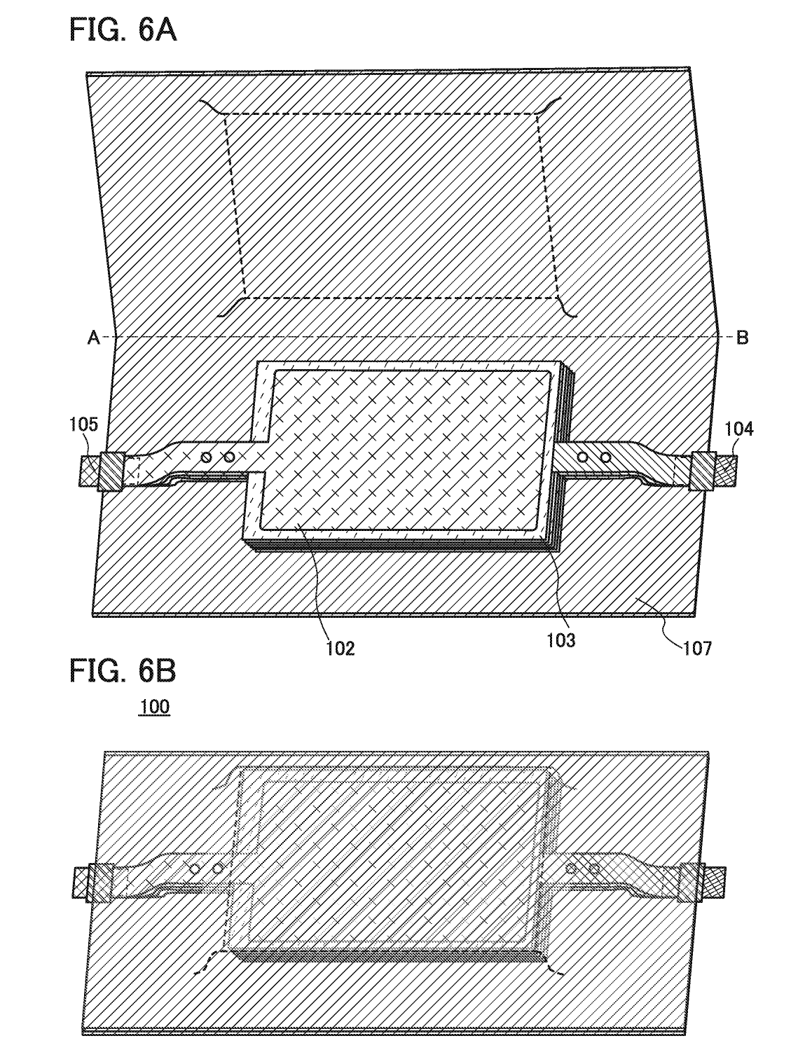

Next, the positive electrodes 101, the negative electrodes 102, and the separators 103 that are stacked are placed over the exterior body 107 as shown in FIG. 6A. Then, the exterior body 107 is folded along a dotted line A-B in the exterior body 107 shown in FIG. 6A so as to be in the state shown in FIG. 6B. Here, the exterior body 107 is folded so that two end portions overlap with each other, and three sides are fixed with a bonding layer to be sealed; however, it is also possible to employ a structure in which two films are stacked and four sides, i.e., four edges of the films are fixed with a bonding layer to be sealed.

### [3. Introduction of Electrolyte Solution]

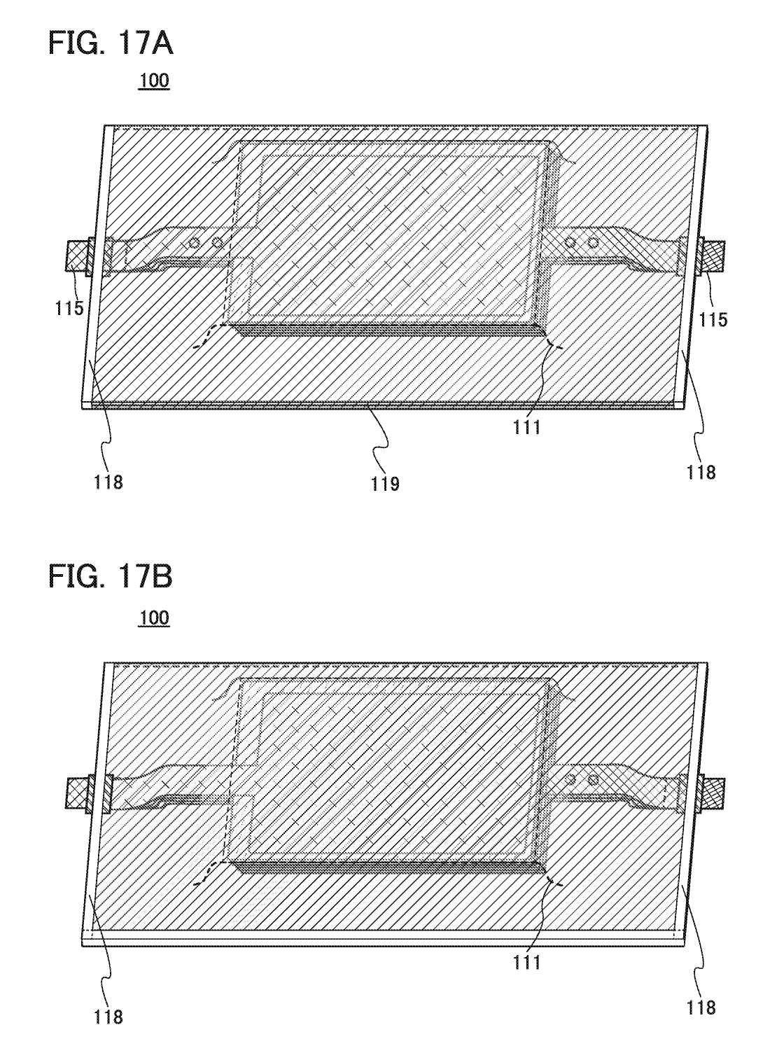

As shown in FIG. 17A, the outer edges of the exterior body 107 except an introduction port 119 for introducing the electrolyte solution 106 are bonded to each other by thermocompression bonding. In thermocompression bonding, the sealing layers 115 provided over the lead electrodes are also melted, thereby fixing the lead electrodes and the exterior body 107 to each other. A portion where the outer edges of the exterior body 107 are bonded is shown as a bonding portion 118 in FIG. 17A.

After that, in a reduced-pressure atmosphere or an inert atmosphere, an electrolyte solution is introduced to the inside of the exterior body 107 through the introduction port 119. Finally, the introduction port 119 is sealed by thermocompression bonding, as illustrated in FIG. 17B. In the above-described manner, the power storage device 100 in FIGS. 1A to 1C can be manufactured.

This embodiment can be implemented in combination with any of the other embodiments as appropriate.

### Embodiment 3

### Structural Example of Power Storage System

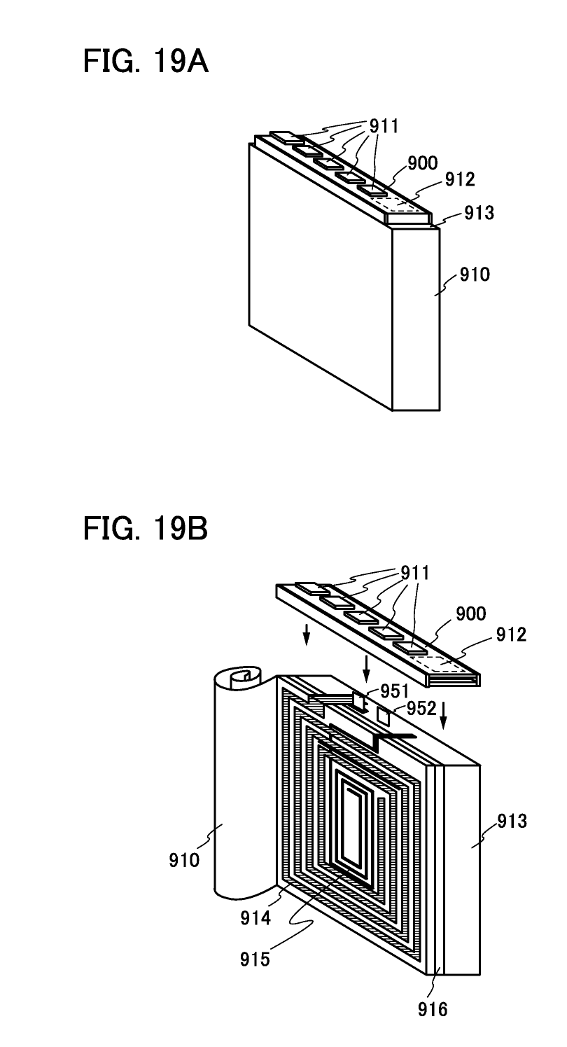

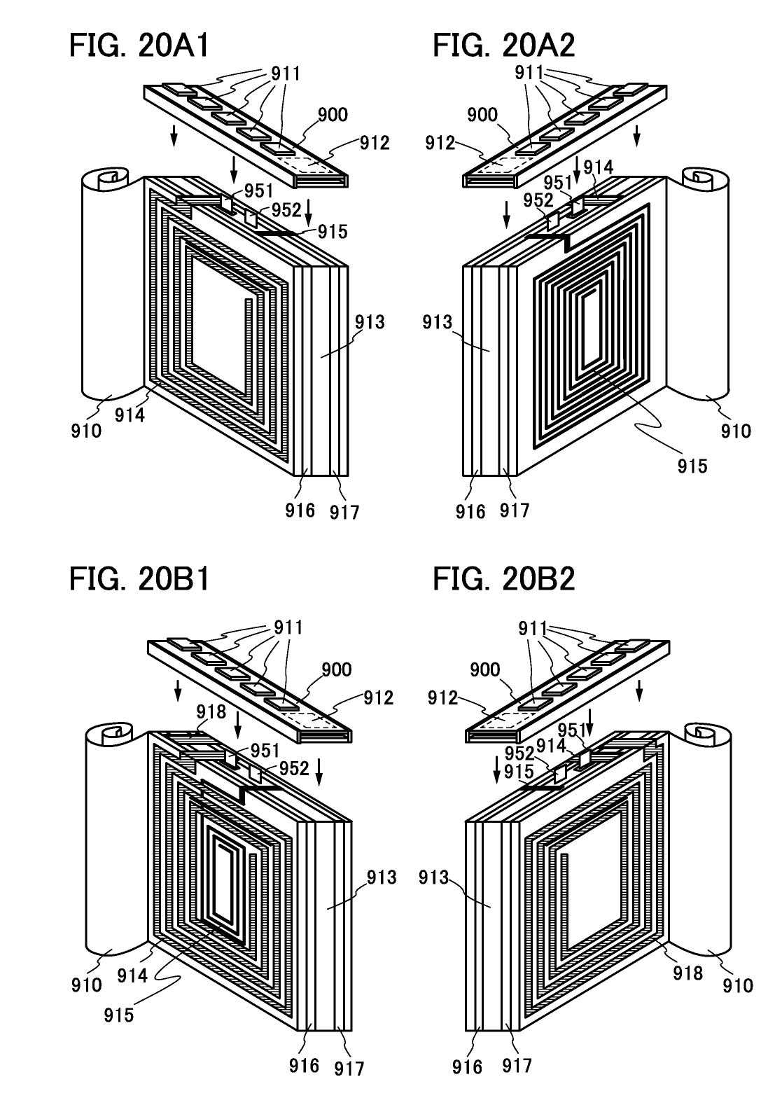

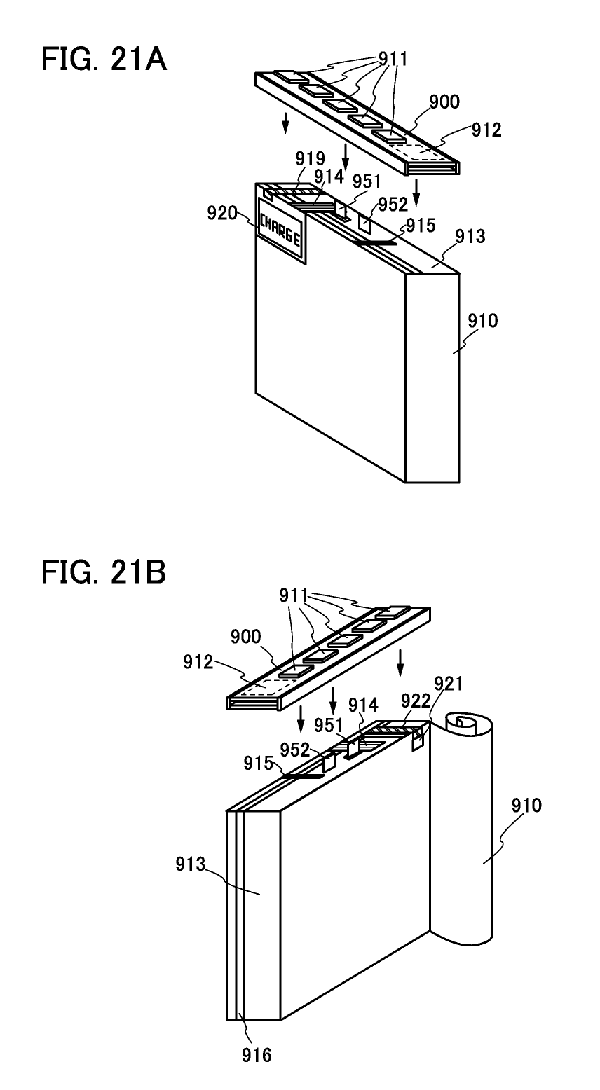

In this embodiment, structural examples of a power storage system are described with reference to FIGS. 19A and 19B, FIGS. 20A1, 20A2, 20B1, and 20B2, and FIGS. 21A and 21B.

FIGS. 19A and 19B show external views of a power storage system. The power storage system includes a circuit board 900 and a power storage device 913. A label 910 is attached to the power storage device 913. As illustrated in FIG. 19B, the power storage system further includes a terminal 951, a terminal 952, and an antenna 914 and an antenna 915 which are provided behind the label 910. Here, the terminals 951 and 952 are led from the same surface of the power storage system; however, the terminals 951 and 952 may be led from different surfaces of the power storage system. For example, a structure may be employed in which the terminal 951 is led from the top surface of the power storage system and the terminal 952 is led from the bottom surface of the power storage system.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear surface of the circuit board 900. Note that the shape of the antennas 914 and 915 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 914 or the antenna 915 may be a flat-plate conductor. The flat-plate conductor can serve as one of conductors for electric field coupling. That is, the antenna 914 or the antenna 915 may serve as one of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage system includes a layer 916 between the power storage device 913 and the antennas 914 and 915. The layer 916 has a function of blocking an electromagnetic field from the power storage device 913, for example. As the layer 916, for example, a magnetic body can be used.

Note that the structure of the power storage system is not limited to that in FIGS. 19A and 19B.

For example, as illustrated in FIGS. 20A1 and 20A2, two opposite sides of the power storage device 913 in FIGS. 19A and 19B may be provided with the respective antennas. FIG. 20A1 is an external view showing one of the sides, and FIG. 20A2 is an external view showing the other of the sides. Note that for the same portions as the power storage system in FIGS. 19A and 19B, description on the power storage system in FIGS. 19A and 19B can be referred to as appropriate.

As illustrated in FIG. 20A1, the antenna 914 is provided on one of the sides of the power storage device 913 with the layer 916 provided therebetween, and as illustrated in FIG. 20A2, the antenna 915 is provided on the other of the sides of the power storage device 913 with a layer 917 provided therebetween. The layer 917 has a function of blocking an electromagnetic field from the power storage device 913, for example. As the layer 917, for example, a magnetic body can be used.

With the above structure, both the antenna 914 and the antenna 915 can be increased in size.

Alternatively, as illustrated in FIGS. 20B1 and 20B2, two opposite sides of the power storage device 913 in FIGS. 19A and 19B may be provided with different types of antennas. FIG. 20B1 is an external view showing one of the sides, and FIG. 20B2 is an external view showing the other of the sides. Note that for the same portions as the power storage system in FIGS. 19A and 19B, description on the power storage system in FIGS. 19A and 19B can be referred to as appropriate.

As illustrated in FIG. 20B1, the antennas 914 and 915 are provided on one of the sides of the power storage device 913 with the layer 916 provided therebetween, and as illustrated in FIG. 20B2, an antenna 918 is provided on the other sides of the power storage device 913 with the layer 917 provided therebetween. The antenna 918 has a function of performing data communication with an external device, for example. An antenna with a shape that can be applied to the antennas 914 and 915 can be used as the antenna 918, for example. As an example of a method for communication between the power storage system and another device via the antenna 918, near field communication (NFC) can be employed.

Alternatively, as illustrated in FIG. 21A, the power storage device 913 in FIGS. 19A and 19B may be provided with a display device 920. The display device 920 is electrically connected to the terminal 911 via a terminal 919. It is possible that the label 910 is not provided in a portion where the display device 920 is provided. Note that for the same portions as the power storage system in FIGS. 19A and 19B, description on the power storage system in FIGS. 19A and 19B can be referred to as appropriate.

The display device 920 can display, for example, an image showing whether or not charging is being carried out or an image showing the amount of stored power. As the display device 920, electronic paper, a liquid crystal display device, an electroluminescent (EL) display device, or the like can be used. For example, the power consumption of the display device 920 can be reduced when electronic paper is used.

Alternatively, as illustrated in FIG. 21B, the power storage device 913 in FIGS. 19A and 19B may be provided with a sensor 921. The sensor 921 is electrically connected to the terminal 911 via a terminal 922. The sensor 921 may be provided behind the label 910. Note that for the same portions as the power storage system in FIGS. 19A and 19B, description on the power storage system in FIGS. 19A and 19B can be referred to as appropriate.

The sensor 921 may have a function of measuring or sensing displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays, for example. With the sensor 921, for example, data on the environment (e.g., temperature) where the power storage device is placed can be acquired and stored in a memory in the circuit 912.

This embodiment can be implemented in combination with any of the other embodiments as appropriate.

### Embodiment 4

In this embodiment, examples of an electronic device including a power storage device are described.

### [1. Example of Electronic Device Including Flexible Power Storage Device]

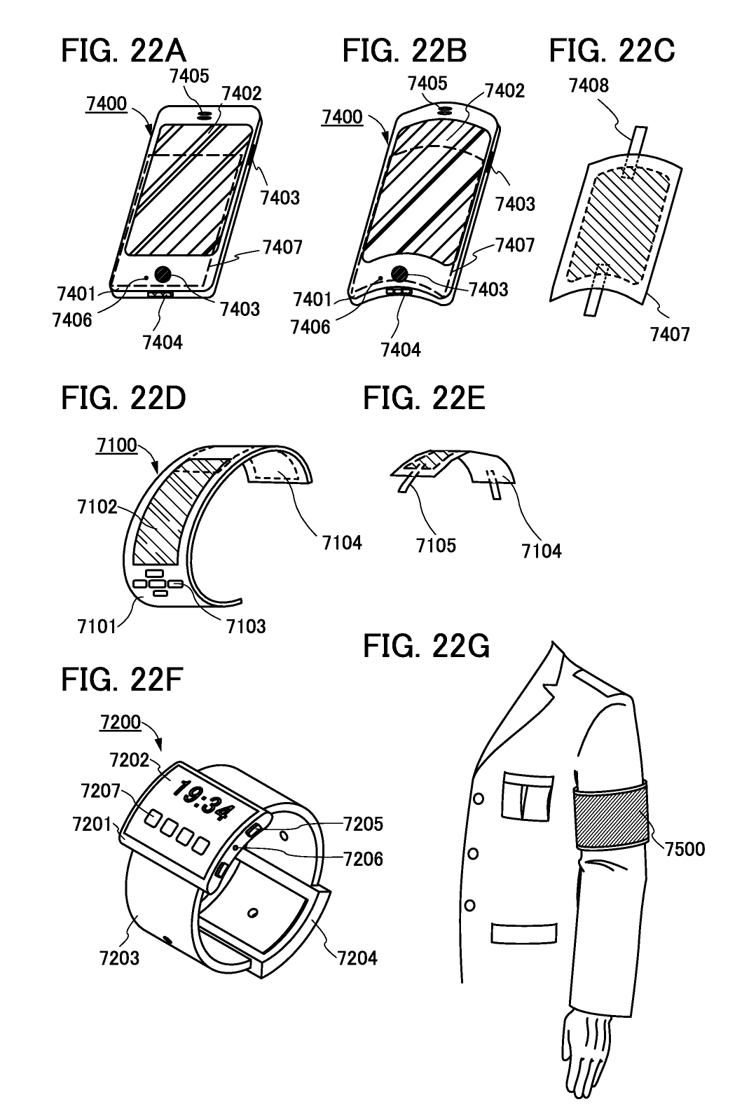

Examples of an electronic device including a flexible and thin power storage device are illustrated in FIGS. 22A to 22G. Examples of an electronic device including a flexible power storage device include television devices (also referred to as televisions or television receivers), monitors of computers or the like, cameras such as digital cameras or digital video cameras, digital photo frames, mobile phones (also referred to as cellular phones or mobile phone devices), portable game machines, portable information terminals, audio reproducing devices, stationary game machines such as pachinko machines, and the like.

A flexible power storage device can be incorporated along a curved inside/outside wall surface of a house or a building or a curved interior/exterior surface of a car.

FIG. 22A illustrates an example of a mobile phone. A mobile phone 7400 includes a display portion 7402 incorporated in a housing 7401, an operation button 7403, an external connection port 7404, a speaker 7405, a microphone 7406, and the like. Note that the mobile phone 7400 includes a power storage device 7407.

The mobile phone 7400 illustrated in FIG. 22B is bent. When the whole mobile phone 7400 is bent by the external force, the power storage device 7407 included in the mobile phone 7400 is also bent. FIG. 22C illustrates the bent power storage device 7407. The power storage device 7407 is a thin power storage device. The power storage device 7407 has a terminal 7408.

FIG. 22D illustrates an example of a bangle display device. A bangle display device 7100 includes a housing 7101, a display portion 7102, an operation button 7103, and a power storage device 7104. FIG. 22E illustrates the bent power storage device 7104. The power storage device 7104 has a terminal 7105.

FIG. 22F illustrates an example of a wrist-watch-type portable information terminal. A portable information terminal 7200 includes a housing 7201, a display portion 7202, a band 7203, a buckle 7204, an operation button 7205, an input output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is bent, and images can be displayed on the bent display surface. Furthermore, the display portion 7202 includes a touch sensor, and operation can be performed by touching the screen with a finger, a stylus, or the like. By touching an icon 7207 displayed on the display portion 7202, application can be started.

With the operation button 7205, a variety of functions such as power ON/OFF, ON/OFF of wireless communication, setting and cancellation of manner mode, and setting and cancellation of power saving mode can be performed. The functions of the operation button 7205 can be set freely by setting the operation system incorporated in the portable information terminal 7200.

Furthermore, the portable information terminal 7200 can employ NFC. In that case, for example, mutual communication between the portable information terminal 7200 and a headset capable of wireless communication can be performed, and thus hands-free calling is possible.

Since the portable information terminal 7200 includes the input output terminal 7206, data can be directly transmitted to and received from another information terminal via a connector. Power charging through the input output terminal 7206 is possible. Note that the charging operation may be performed by wireless power feeding without using the input output terminal 7206.

The display portion 7202 of the portable information terminal 7200 includes the power storage device of one embodiment of the present invention. For example, the power storage device 7104 shown in FIG. 22E can be incorporated in the housing 7201 with a state where the power storage device 7104 is bent or can be incorporated in the band 7203 with a state where the power storage device 7104 is bent.

An armband 7500 illustrated in FIG. 22G has the same functions as the electronic devices illustrated in FIGS. 22B, 22D, and 22F. The armband 7500 preferably includes the power storage device 7104, as the electronic device illustrated in FIG. 22F does. The armband 7500 may be sewn on clothes. When the armband 7500 can be supplied with power wirelessly, power can be supplied to the armband 7500 fixed on clothes.

### [2. Example of Electronic Device]

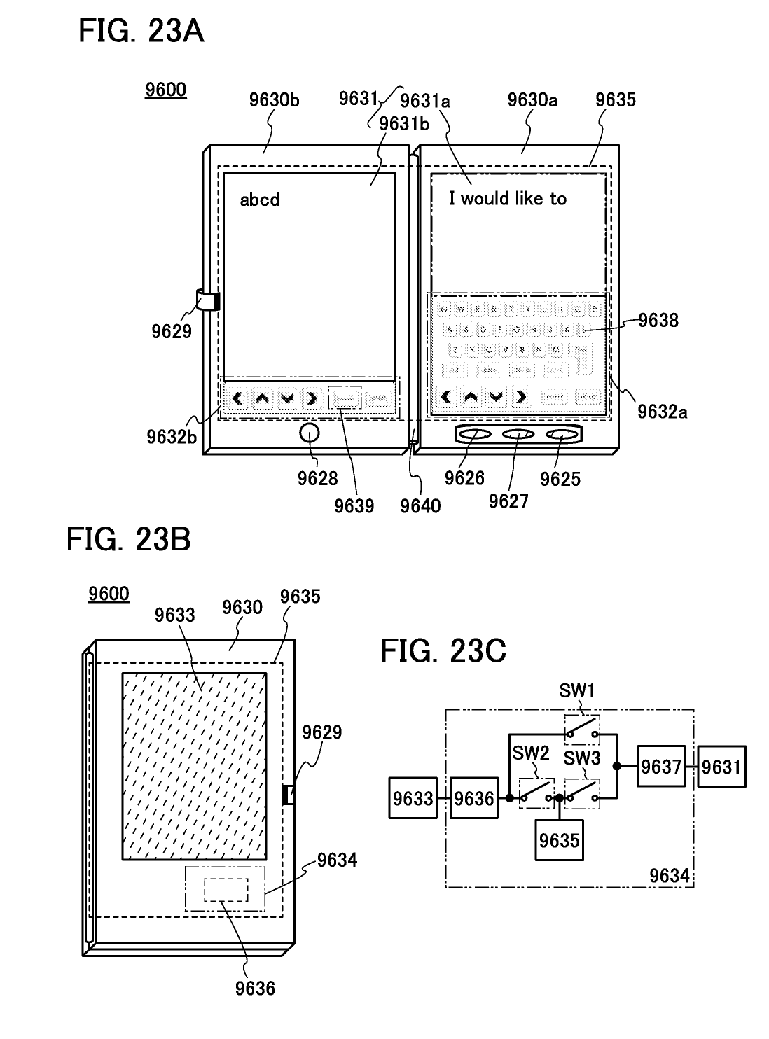

FIGS. 23A and 23B illustrate an example of a foldable tablet terminal. A tablet terminal 9600 illustrated in FIGS. 23A and 23B includes a housing 9630a, a housing 9630b, a movable portion 9640 connecting the housings 9630a and 9630b, a display portion 9631 provided with a display portion 9631a and a display portion 9631b, a display mode switch 9626, a power switch 9627, a power saver switch 9625, a fastener 9629, and an operation switch 9628. FIGS. 23A and 23B illustrate the tablet terminal 9600 opened and closed, respectively.

The tablet terminal 9600 includes a power storage device 9635 inside the housings 9630a and 9630b. The power storage device 9635 is provided across the housings 9630a and 9630b, passing through the movable portion 9640.

Part of the display portion 9631a can be a touch panel region 9632a and data can be input when a displayed operation key 9638 is touched. Although a structure in which a half region in the display portion 9631a has only a display function and the other half region also has a touchscreen function is illustrated as an example, the structure of the display portion 9631a is not limited thereto. The whole area of the display portion 9631a may have a touch panel function. For example, the whole area of the display portion 9631a can display keyboard buttons and serve as a touch panel while the display portion 9631b can be used as a display screen.

As in the display portion 9631a, part of the display portion 9631b can be a touch panel region 9632b. When a keyboard display switching button 9639 displayed on the touch panel is touched with a finger, a stylus, or the like, a keyboard can be displayed on the display portion 9631b.

Touch input can be performed in the touch panel region 9632a and the touch panel region 9632b at the same time.

The display mode switch 9626 can switch the display between portrait mode, landscape mode, and the like, and between monochrome display and color display, for example. The power saver switch 9625 can control display luminance in accordance with the amount of external light in use of the tablet terminal 9600, which is measured with an optical sensor incorporated in the tablet terminal 9600. The tablet terminal may include another detection device such as a gyroscope or an acceleration sensor in addition to the optical sensor.

Although the display portion 9631a and the display portion 9631b have the same display area in FIG. 23A, one embodiment of the present invention is not limited to this structure. The display portions 9631a and 9631b may have different display areas and different display quality. For example, higher-resolution images may be displayed on one of the display portions 9631a and 9631b.

The tablet terminal is closed in FIG. 23B. The tablet terminal includes the housing 9630, a solar cell 9633, and a charge and discharge control circuit 9634 including a DC-DC converter 9636. The power storage device of one embodiment of the present invention is used as the power storage device 9635.

The tablet terminal 9600 can be folded in two so that the housings 9630a and 9630b overlap with each other when not in use. Thus, the display portions 9631a and 9631b can be protected, which increases the durability of the tablet terminal 9600. In addition, the power storage device 9635, which is a power storage device of one embodiment of the present invention, has flexibility and can be repeatedly folded without a large decrease in charge and discharge capacity. Thus, a highly reliable tablet terminal can be provided.

The tablet terminal illustrated in FIGS. 23A and 23B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processor, and the like. Note that the solar cell 9633 can be provided on one or both surfaces of the housing 9630 and the power storage device 9635 can be charged efficiently. The use of a lithium-ion battery as the power storage device 9635 brings an advantage such as a reduction in size.

The structure and operation of the charge and discharge control circuit 9634 in FIG. 23B are described with reference to a block diagram in FIG. 23C. The solar cell 9633, the power storage device 9635, the DC-DC converter 9636, a converter 9637, switches SW1 to SW3, and the display portion 9631 are illustrated in FIG. 23C, and the power storage device 9635, the DC-DC converter 9636, the converter 9637, and the switches SW1 to SW3 correspond to the charge and discharge control circuit 9634 in FIG. 23B.

First, an example of the operation in the case where electric power is generated by the solar cell 9633 using external light is described. The voltage of electric power generated by the solar cell is raised or lowered by the DC-DC converter 9636 to a voltage for charging the power storage device 9635. Then, when the electric power from the solar cell 9633 is used for the operation of the display portion 9631, the switch SW1 is turned on and the voltage of the electric power is raised or lowered by the converter 9637 to a voltage needed for the display portion 9631. When display on the display portion 9631 is not performed, the switch SW1 is turned off and the switch SW2 is turned on, so that the power storage device 9635 can be charged.

Note that the solar cell 9633 is described as an example of a power generation means; however, one embodiment of the present invention is not limited to this example. The power storage device 9635 may be charged using another power generation means such as a piezoelectric element or a thermoelectric conversion element (Peltier element). For example, the power storage device 9635 may be charged using a non-contact power transmission module that transmits and receives electric power wirelessly (without contact) or using another charging means in combination.

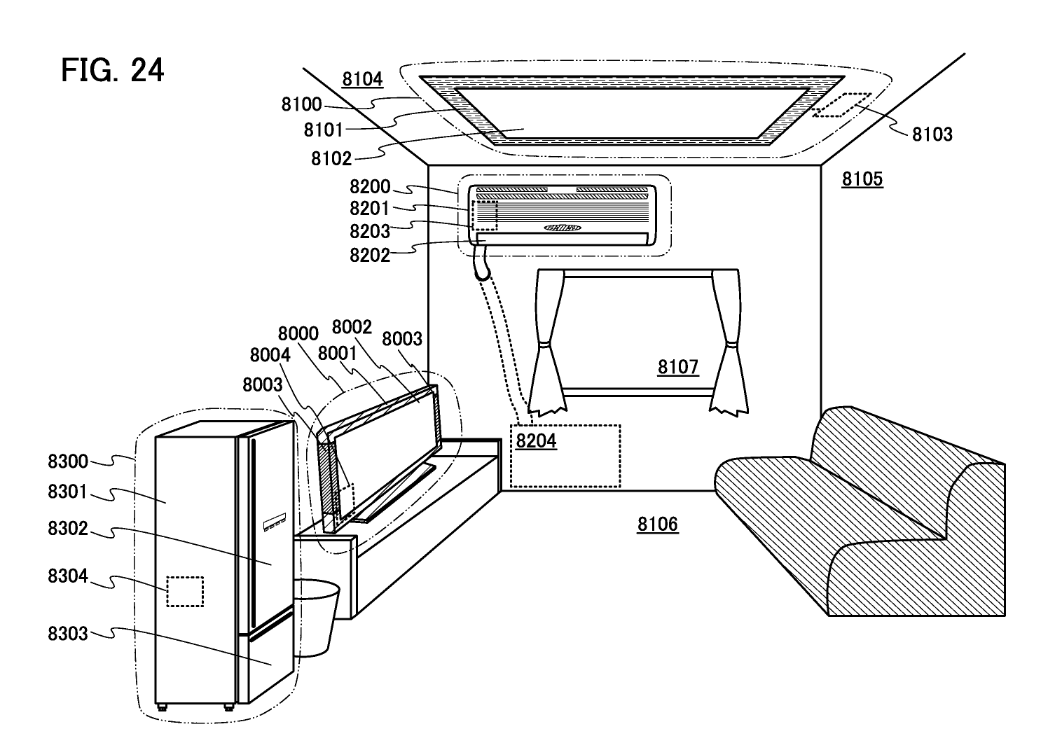

FIG. 24 illustrates examples of other electronic devices. In FIG. 24, a display device 8000 is an example of an electronic device including a power storage device 8004 of one embodiment of the present invention. Specifically, the display device 8000 corresponds to a display device for TV broadcast reception and includes a housing 8001, a display portion 8002, speaker portions 8003, the power storage device 8004, and the like. The power storage device 8004 of one embodiment of the present invention is provided in the housing 8001. The display device 8000 can receive electric power from a commercial power source or use electric power stored in the power storage device 8004. Thus, the display device 8000 can operate with the use of the power storage device 8004 of one embodiment of the present invention as an uninterruptible power source even when electric power cannot be supplied from a commercial power source because of power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all information display devices for personal computers, advertisement displays, and the like besides the ones for TV broadcast reception.

In FIG. 24, an installation lighting device 8100 is an example of an electronic device including a power storage device 8103 of one embodiment of the present invention. Specifically, the lighting device 8100 includes a housing 8101, a light source 8102, the power storage device 8103, and the like. Although FIG. 24 illustrates the case where the power storage device 8103 is provided in a ceiling 8104 on which the housing 8101 and the light source 8102 are installed, the power storage device 8103 may be provided in the housing 8101. The lighting device 8100 can receive electric power from a commercial power source or use electric power stored in the power storage device 8103. Thus, the lighting device 8100 can operate with the use of the power storage device 8103 of one embodiment of the present invention as an uninterruptible power source even when electric power cannot be supplied from a commercial power source because of power failure or the like.

Note that although the installation lighting device 8100 provided in the ceiling 8104 is illustrated in FIG. 24 as an example, the power storage device of one embodiment of the present invention can be used in an installation lighting device provided in, for example, a wall 8105, a floor 8106, a window 8107, or the like besides the ceiling 8104. Alternatively, the power storage device can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 24, an air conditioner including an indoor unit 8200 and an outdoor unit 8204 is an example of an electronic device including a power storage device 8203 of one embodiment of the present invention. Specifically, the indoor unit 8200 includes a housing 8201, an air outlet 8202, the power storage device 8203, and the like. Although FIG. 24 illustrates the case where the power storage device 8203 is provided in the indoor unit 8200, the power storage device 8203 may be provided in the outdoor unit 8204. Alternatively, the power storage device 8203 may be provided in both the indoor unit 8200 and the outdoor unit 8204. The air conditioner can receive electric power from a commercial power source or use electric power stored in the power storage device 8203. Particularly in the case where the power storage device 8203 is provided in both the indoor unit 8200 and the outdoor unit 8204, the air conditioner can operate with the use of the power storage device 8203 of one embodiment of the present invention as an uninterruptible power source even when electric power cannot be supplied from a commercial power source because of power failure or the like.

Note that although the split-type air conditioner including the indoor unit and the outdoor unit is illustrated in FIG. 24 as an example, the power storage device of one embodiment of the present invention can be used in an air conditioner in which the functions of an indoor unit and an outdoor unit are integrated in one housing.

In FIG. 24, an electric refrigerator-freezer 8300 is an example of an electronic device including a power storage device 8304 of one embodiment of the present invention. Specifically, the electric refrigerator-freezer 8300 includes a housing 8301, a door for a refrigerator 8302, a door for a freezer 8303, the power storage device 8304, and the like. The power storage device 8304 is provided in the housing 8301 in FIG. 24. The electric refrigerator-freezer 8300 can receive electric power from a commercial power source or use electric power stored in the power storage device 8304. Thus, the electric refrigerator-freezer 8300 can operate with the use of the power storage device 8304 of one embodiment of the present invention as an uninterruptible power source even when electric power cannot be supplied from a commercial power source because of power failure or the like.

Note that electronic devices such as microwave ovens and electric rice cookers require high electric power in a short time. The tripping of a circuit breaker of a commercial power source in use of the electronic devices can be prevented by using the power storage device of one embodiment of the present invention as an auxiliary power source for making up for the shortfall in electric power supplied from a commercial power source.

In addition, in a time period when electronic devices are not used, specifically when the proportion of the electric power which is actually used to the total amount of electric power which can be supplied from a commercial power source (such a proportion is referred to as power usage rate) is low, electric power can be stored in the power storage device, whereby the power usage rate can be reduced in a time period when the electronic devices are used. For example, in the case of the electric refrigerator-freezer 8300, electric power can be stored in the power storage device 8304 in night time when the temperature is low and the door for a refrigerator 8302 and the door for a freezer 8303 are not often opened or closed. On the other hand, in daytime when the temperature is high and the door for a refrigerator 8302 and the door for a freezer 8303 are frequently opened and closed, the power storage device 8304 is used as an auxiliary power source; thus, the power usage rate in daytime can be reduced.

The use of a power storage device in vehicles can lead to next-generation clean energy vehicles such as hybrid electric vehicles (HEVs), electric vehicles (EVs), and plug-in hybrid electric vehicles (PHEVs).

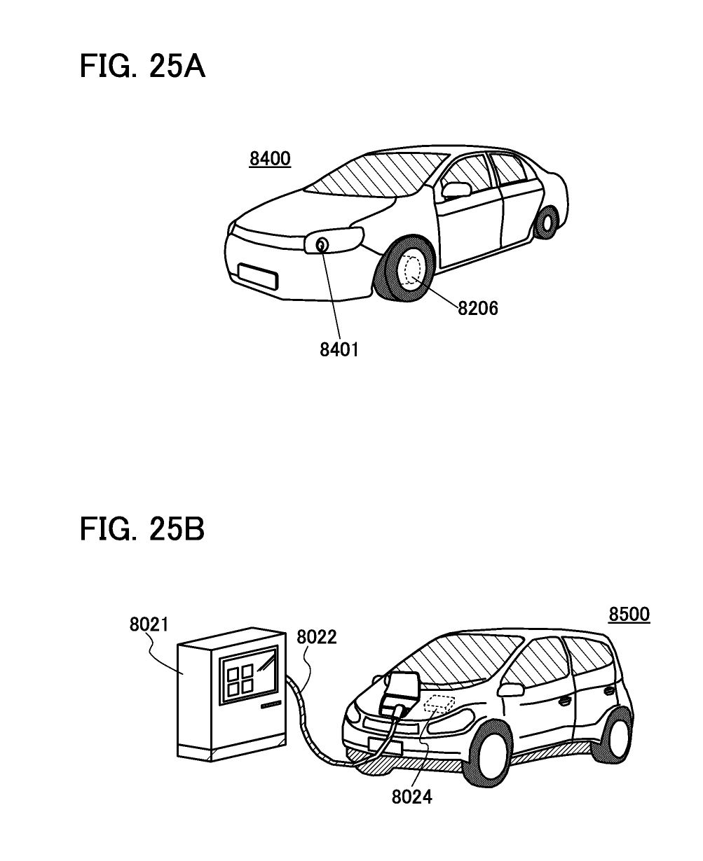

FIGS. 25A and 25B each illustrate an example of a vehicle using one embodiment of the present invention. An automobile 8400 illustrated in FIG. 25A is an electric vehicle which runs on the power of the electric motor. Alternatively, the automobile 8400 is a hybrid electric vehicle capable of driving using either the electric motor or the engine as appropriate. One embodiment of the present invention achieves a high-mileage vehicle. The automobile 8400 includes the power storage device. The power storage device is used not only for driving an electric motor 8206, but also for supplying electric power to a light-emitting device such as a headlight 8401 or a room light (not illustrated).

The power storage device can also supply electric power to a display device included in the automobile 8400, such as a speedometer or a tachometer. Furthermore, the power storage device can supply electric power to a semiconductor device included in the automobile 8400, such as a navigation system.

FIG. 25B illustrates an automobile 8500 including the power storage device. The automobile 8500 can be charged when a power storage device 8024 is supplied with electric power through external charging equipment by a plug-in system, a contactless power supply system, or the like. In FIG. 25B, the power storage device 8024 included in the automobile 8500 is charged with the use of a ground-based charging apparatus 8021 through a cable 8022. In charging, a given method such as CHAdeMO (registered trademark) or Combined Charging System may be referred to for a charging method, the standard of a connector, or the like as appropriate. The charging apparatus 8021 may be a charging station provided in a commerce facility or a power source in a house. For example, with the use of a plug-in technique, a power storage device 8024 included in the automobile 8500 can be charged by being supplied with electric power from outside. The charging can be performed by converting AC electric power into DC electric power through a converter such as an AC-DC converter.

Although not illustrated, the vehicle may include a power receiving device so as to be charged by being supplied with electric power from an above-ground power transmitting device in a contactless manner. In the case of the contactless power supply system, by fitting the power transmitting device in a road or an exterior wall, charging can be performed not only when the automobile is stopped but also when driven. In addition, the contactless power supply system may be utilized to perform transmission/reception between vehicles. Furthermore, a solar cell may be provided in the exterior of the automobile to charge the power storage device when the automobile is stopped or driven. To supply electric power in such a contactless manner, an electromagnetic induction method or a magnetic resonance method can be used. The automobile 8400 in FIG. 25A and the automobile 8500 in FIG. 25B may include a bendable power storage device. The bendable power storage device is easily placed along a curved surface of the automobile, so that the interior space of the automobile can be used efficiently. Furthermore, the power storage device can have a large inner volume and high capacity. In addition, the same power storage devices can be provided to a variety of automobiles having different shapes so that the power storage devices fit their shapes. The bendable power storage device can fit the shape of any part such as a ceiling, an interior wall, or a bottom portion in the automobile.

According to one embodiment of the present invention, the power storage device can have improved cycle characteristics and reliability. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the driving distance. Moreover, the power storage device included in the vehicle can be used as a power source of products other than the vehicle. In that case, the use of a commercial power supply can be avoided at peak time of electric power demand.

This embodiment can be implemented in combination with any of the other embodiments as appropriate.

This application is based on Japanese Patent Application serial no. 2013-253409 filed with Japan Patent Office on Dec. 6, 2013, the entire contents of which are hereby incorporated by reference.

What is claimed is:

1. A power storage device comprising:
an exterior body; and
a positive electrode and a negative electrode in the exterior body,
wherein:
the positive electrode comprises a first tab region which extends outside the exterior body so as to electrically connect the positive electrode to a positive electrode lead;
the negative electrode comprises a second tab region which extends outside the exterior body so as to electrically connect the negative electrode to a negative electrode lead; and
each of the first tab region and the second tab region comprises a plurality of holes which are placed in the exterior body.

2. The power storage device according to claim 1,
wherein:
the plurality of holes of the first tab region are aligned in a direction in which the first tab region extends; and
the plurality of holes of the second tab region are aligned in a direction in which the second tab region extends.

3. The power storage device according to claim 1,
wherein:
the plurality of holes of the first tab region are aligned in a direction perpendicular to a direction in which the first tab region extends; and
the plurality of holes of the second tab region are aligned in a direction perpendicular to a direction in which the second tab region extends.

4. The power storage device according to claim 1, further comprising a separator between the positive electrode and the negative electrode,
wherein:
the positive electrode and the negative electrode each has a sheet shape; and
the separator covers an end portion of the positive electrode and an end portion of the negative electrode.

5. The power storage device according to claim 1, further comprising:
a second positive electrode over the positive electrode with the negative electrode interposed therebetween,
wherein:
the second positive electrode comprises a third tab region which extends outside the exterior body so as to electrically connect the second positive electrode to the positive electrode lead;
the third tab region overlaps with the first tab region and comprises a hole; and
the hole of the third tab region and one of the plurality of holes of the first tab region overlap with each other.

6. An electronic device comprising the power storage device according to claim 1.

7. A method for fabricating a power storage device, the method comprising steps of:
placing a second electrode over a first electrode, the first electrode comprising a first tab region which extends outside the exterior body and has a plurality of holes;
placing a third electrode over the second electrode, the third electrode comprising a third tab region which extends outside the exterior body and has a plurality of holes; and
aligning the first electrode and the third electrode by passing a first pin through one of the plurality of holes of the first tab region and one of the plurality of holes of the third tab region and passing a second pin through another one of the plurality of holes of the first tab region and another one of the plurality of holes of the third tab region.

8. The method according to claim 7, further comprising a step of:
bonding the first tab region with the third tab region.

9. The method according to claim 8, further comprising a step of:
enveloping the first electrode, the second electrode, and the third electrode in an exterior body so that the first tab region and the third tab region extend outside the exterior body.

10. The method according to claim 9,
wherein the first electrode, the second electrode, and the third electrode are enveloped in the exterior body so that the plurality of holes of the first tab region and the plurality of holes of the third tab region are placed in the exterior body.

11. A bundle of electrodes comprising:
a first electrode; and
a second electrode connected with the first electrode,
wherein:
the first electrode comprises a first tab region extending to a bonding portion in which the first electrode and the second electrode are electrically connected to each other;
the second electrode comprises a second tab region extending to the bonding portion;
each of the first tab region and the second tab region comprises a plurality of holes;
the plurality of holes of the first tab region are aligned in a direction in which the first tab region extends; and
the plurality of holes of the second tab region are aligned in a direction in which the second tab region extends.

12. The bundle of electrodes according to claim 11,
wherein one of the plurality of holes of the first tab region overlaps with one of the plurality of holes of the second tab region.

13. The bundle of electrodes according to claim 12,
wherein another one of the plurality of holes of the first tab region overlaps with another one of the plurality of holes of the second tab region.

14. The bundle of electrodes according to claim 11, further comprising a member,
wherein one of the plurality of holes of the first tab region and one of the plurality of holes of the second tab region are filled with the member.

15. The bundle of electrodes according to claim 11, further comprising a clasp,
wherein:
the clasp comprises a first pin and a second pin;
the first pin passes through one of the plurality of holes of the first tab region and one of the plurality of holes of the second tab region; and
the second pin passes through another one of the plurality of holes of the first tab region and another one of the plurality of holes of the second tab region.

16. The bundle of electrodes according to claim 15,
wherein the first pin and the second pin are bent so that an upper portion of the first pin and an upper portion of the second pin are in contact with each other.
